(19) United States
(12) Patent Application Publication
(10) Pub. No.: US 2006/0080257 A1
(43) Pub. Date: Apr. 13, 2006

(54) Digital content distribution framework

(75) Inventors: Michael J. Vaughan, Newton, MA (US); Erich K. Jacobs, Lexington, MA (US); Craig S. Brusseau, White Horse Beach, MA (US); Norman J. Dumont, Fall River, MA (US); Bruce D. Penney, Arlington, MA (US); John M. Covino, Westborough, MA (US)

Correspondence Address: FAEGRE & BENSON LLP;PATENT DOCKETING, 2200 WELLS FARGO CENTER, MINNEAPOLIS, MN, 55402, US

(73) Assignee: LEVEL 3 COMMUNICATIONS, INC., Broomfield, CO (US)

(21) Appl. No.: 10/961,811

(22) Filed: Oct. 8, 2004

(51) Int. Cl. G06Q 99/00

(52) U.S. Cl. 705/51

(57) ABSTRACT

A digital content distribution framework is provided. According to one embodiment, a digital content distribution system, such as a software distribution system, includes a credentialing authority, an access control component, and a digital content distribution system interface for each participant in the system. The credentialing authority component is configured to receive encryption keys associated with the participants and assign each of the participants an identity certificate for use during subsequent interactions with components of the digital content distribution system. The access control component is configured to maintain information regarding access rights of the participants to digital content accessible via the digital content distribution system. The digital content distribution system interfaces are capable of being customized for the corresponding participant and are configured to coordinate interactions among the corresponding participant and the components of the digital content distribution system according to predetermined business processes associated with the corresponding participant.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2004 Level 3 Communications, Inc.

### BACKGROUND

1. Field

Embodiments of the present invention generally relate to the field of distribution of digital content. More particularly, embodiments of the present invention relate to a framework that facilitates a digital distribution model and interaction among entities, such as publishers, distributors, resellers, providers, and consumers (e.g., enterprises, small/medium businesses (SMBs) and end users), typically involved in licensing, installation, running, and maintenance of software products.

2. Description of the Related Art

The cost and complexity of existing software distribution and upgrade models create deployment resistance. At present, a number of disjointed, partial solutions directed at software distribution are provided by software publishers, value-added resellers (VARs) and large account resellers (LARs). Such partial solutions are problematic in that they typically require an enterprise or SMB customer to implement a different system or set of procedures for each product/vendor.

Meanwhile, large enterprises are choosing to skip upgrades in order to avoid incremental deployment costs. Empirical evidence suggests it often costs enterprises 250% more than the price of the software product to deploy the application throughout the enterprise. As a result of this deployment resistance, publishers lose significant potential new and recurring revenue from upgrades. Additionally, enterprises that delay upgrades increase their maintenance costs and forego potential increased productivity that would otherwise result from newer IT infrastructure.

Consequently, a need exists for a uniform yet flexible software distribution framework to facilitate the digital distribution and deployment of software.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 is a high-level architectural view of an end-to-end digital content distribution system according to one embodiment of the present invention.

FIG. 2 conceptually illustrates various roles that may participate in a software distribution framework and components/services that may facilitate interactions among the various roles according to one embodiment of the present invention.

FIG. 3 is an example of a computer system with which embodiments of the present invention may be utilized.

FIG. 4 conceptually illustrates high-level interactions among components and participants in a software distribution framework to accomplish end-to-end electronic software distribution from a publisher to an enterprise according to one embodiment of the present invention.

FIG. 5 conceptually illustrates interactions between an identity manager and an enterprise during client registration and client session establishment according to one embodiment of the present invention.

FIG. 6 is a flow diagram illustrating client session establishment processing according to one embodiment of the present invention.

FIG. 7 is a flow diagram illustrating identity manager client authentication processing according to one embodiment of the present invention.

FIG. 8 conceptually illustrates interactions among a rights authority, an enterprise, and a seller according to one embodiment of the present invention.

FIG. 9 is a flow diagram illustrating the processing involved in connection with addition of an enterprise/seller contract to a rights authority according to one embodiment of the present invention.

FIG. 10 is a flow diagram illustrating processing involved in retrieving information regarding an enterprise's software licenses from a rights authority according to one embodiment of the present invention.

FIG. 11 conceptually illustrates interactions among a rights authority, an enterprise, and a provider according to one embodiment of the present invention.

FIG. 12 conceptually illustrates a high-level architectural view of a software distribution framework component according to one embodiment of the present invention.

FIG. 13 conceptually illustrates a more detailed architectural view of a software distribution framework component according to one embodiment of the present invention.

### SUMMARY

A centralized digital content distribution framework and services in support thereof are described to facilitate digital content distribution. According to one embodiment, a digital content distribution system includes a credentialing authority, an access control component, and a digital content distribution system interface for each participant in the digital content distribution system. The credentialing authority component is configured to receive encryption keys associated with the participants in the digital content distribution system and assign each of the participants an identity certificate for use during subsequent interactions with components of the digital content distribution system. The access control component is configured to maintain information regarding access rights of the participants to digital content accessible via the digital content distribution system. The digital content distribution system interfaces are capable of being customized for the corresponding participant and are configured to coordinate interactions among the corresponding participant and the components of the digital content distribution system according to predetermined business processes associated with the corresponding participant.

According to one embodiment, registered participants in a digital content distribution system interact with an identity management component of the digital content distribution system to establish a session with the digital content distribution system. The identity management component receives a session establishment request from a registered participant. Then, the identity management component generates an identity credential digitally signed by the identity management component and returns the identity credential to the registered participant. The identity credential allows the registered participant to obtain access to content distribution services provided by the components of the digital content distribution system.

According to one embodiment, a method of managing rights to software is provided. An access control component of a software distribution system receives a notification regarding an enterprise/seller contract relating to a software product stored by the access control component of the software distribution system. The notification contains information regarding the enterprise/seller contract including information indicative of a registered enterprise consumer participant in the software distribution system and information indicative of the software product associated with the enterprise/seller contract. Subsequently, the access control component receives a consumption request from the registered enterprise consumer participant. The consumption request includes information indicative of the software product and an identity credential issued by a credentialing authority component of the software distribution system. Responsive to the consumption request, the access control component validates the consumption request and authenticates the identity of the enterprise consumer participant based upon the identity credential. After confirming the validity of the consumption request and confirming the identity of the enterprise consumer participant, the software distribution system transmits digital content representing the software product to the enterprise consumer participant.

Other features of embodiments of the present invention will be apparent from the accompanying drawings and from the detailed description that follows.

### DETAILED DESCRIPTION

A centralized digital content distribution framework and services in support thereof are described. Broadly stated, embodiments of the present invention seek to provide a flexible, scalable, industry-wide solution for distribution of digital content, such as software. According to one embodiment, a centralized software distribution framework is provided that facilitates the distribution of software from distributors to enterprises in a fast, flexible, reliable, and secure manner. The software distribution framework may also provide a centralized environment for the dissemination of product and licensing information.

In the following description, for the purposes of explanation, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention may be described with reference to Microsoft® NET software technologies, Simple Object Access Protocol (SOAP), and Extensible Markup Language (XML), Web Services Description Language (WSDL), and Universal Description, Discovery and Integration (UDDI), the present invention is equally applicable to various other software technologies, web services platforms, wire protocols, discovery mechanisms and description languages. For example, embodiments of the present invention may also be implemented with Java Technology, such as Java 2 Platform, Enterprise Edition (J2EE) software technologies available from Sun Microsystems, various other standards developed by the Organization for the Advancement of Structured Information Standards (OASIS), and the like. Similarly, various alternative serialized message, framing and protocol binding mechanisms may be employed and endpoint description and registry of endpoints may be in accordance with substitutes for UDDI and WSDL.

Finally, for purposes of illustration and for the sake of brevity, embodiments of the present invention are described in the context of a software distribution framework; however, the techniques and methodologies described herein are thought to be broadly applicable to the distribution of digital content in general.

Terminology

Brief definitions of terms used throughout this application are given below.

The term “certificate” generally refers to an electronic document used to identify an individual, a server, a company, or some other entity and to associate that identity with a public key.

The terms “connected” or “coupled” and related terms are used in an operational sense and are not necessarily limited to a direct or physical connection or coupling.

The phrase “content distribution framework” generally refers to a collection of components intended to facilitate commerce and interactions among entities relating to digital content. According to one embodiment, a content distribution network enables participants, depending on their respective roles to, source, provide, commercialize, manage access to, deliver, license, sell, lease, purchase, consume, subscribe to, or otherwise exchange and make use of digital content, including, but not limited to, software products, music, videos, movies, online news periodicals, electronic books, and the like. The collection of components may include internally hosted applications, business processes, data stores, web services, and/or application programming interfaces (APIs).

The term “deployment” generally refers to the act of installing a software product onto a computer system.

The phrase “distributed component technologies” generally refers to protocols, APIs, technologies and standards for representing data and/or objects that allow software components to communicate within or across platforms and/or within or across networks, such as Remote Procedure call (RPC), Object Remote Procedure Call (ORPC), Component Object Model (COM), Distributed Component Object Model (DCOM), Common Object Request Broker Architecture (CORBA), Java Remote Method Invocation (Java RMI), messaging (MSMQ, MQSeries), Document Object Model (DOM), Extensible Markup Language (XML), XML Path Language (Xpath), Extensible Stylesheet Language Transformations (XSLT), Document Type Definitions (DTDs), XML Schema, XML Schema Definition (XSD), Simple Object Access Protocol (SOAP), Web Services Description Language (WSDL), and Universal Description, Discovery and Integration (UDDI).

The phrase “encryption key” generally refers to a byte stream that controls how data is enciphered, deciphered, or authenticated.

The term “entitlement” generally refers to a right or claim to something. According to embodiments of the present invention, enterprise users are granted the right (entitled) to use a license to digital content, such as a software product, owned by an enterprise in order to complete duties assigned to them.

The term “identity credential” generally refers to a software data structure or object, such as a token, provided by a credentialing authority that operates as evidence of or confirmation of the identity of the user presenting the identity credential. Examples of identity credentials include digital certificates, cookies and the like. According to one embodiment, a context object or session token signed by an identity manager component of the SDF serves as an identity credential that participants in the SDF may present to components of the SDF to obtain access to the various services provided by the SDF.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The phrase “public key” generally refers to one of a pair of encryption keys used in connection with an asymmetric-key encryption system that is published and/or otherwise made freely available and associated with a particular individual, server, company, or other entity that wishes to receive encrypted data from one or more other entities, authenticate its identity electronically, and/or allow other entities to validate the integrity of signed data transmitted to such other entities by such particular individual, server, company, or other entity. Without loss of generality, exemplary public keys include public keys associated with current or future Public-Key Infrastructure (PKI) standards, such as Public-Key Infrastructure (X.509) (pkix) public keys, Simple Public Key Infrastructure (SPKI) public keys, and Pretty Good Privacy (PGP) public keys.

The term “publisher” generally refers to a participant in a content distribution framework that supplies digital content. In the context of software distribution, examples of potential publishers include, but are not limited to, Adobe Systems Incorporated, Citrix Systems, Inc., Computer Associates International, Inc., Corel Corporation, Crystal Decisions, Datawatch Corporation, FileMaker, Inc., Jasc Software, Inc., Macromedia, Inc., Mathsoft Engineering & Education, Inc., Microsoft Corporation, MKS Inc., Scansoft, Inc., Sun Microsystems, Inc., Symantec Corporation, Trend Micro, Inc., VERITAS Software Corporation, and WRQ, Inc.

The phrase “private key” generally refers to an encryption key that is kept secret. In the context of symmetric-key encryption, encryption keys utilized by sender and receiver of encrypted messages are private keys. In the context of asymmetric-key encryption, a private key refers to an encryption key corresponding to a public key.

The term “provider” generally refers to a participant in a content distribution framework that hosts digital content. In the context of software distribution, an example of a provider would be an entity hosting and providing access to virtualized software, such as SoftGrid-enabled software applications (Softricity SoftGrid is available from Softricity, Inc. of Boston, Mass.).

The term “responsive” includes completely or partially responsive.

The phrase “routing table” generally refers to a data structure or object, for example, containing information regarding the location of one or more SDF components. Location information may be conveyed in various ways, such as by machine name, domain name, URL, pointer, and/or a local/remote indicator. According to one embodiment, the routing table comprises a list of target locations for each registered SDF component. In one embodiment, the routing table may also include location information regarding SDF participants.

The term “seller” generally refers to a participant in a content distribution framework that resells digital content created by one or more publishers. In the context of software distribution, an example of a potential seller would be Software Spectrum, Inc. (SSI).

The phrase “software distribution framework” or “SDF” generally refers to a content distribution framework involving the commercialization of software products.

The phrase “software kit” generally refers to digital content representing a software product or upgrade and other optional components and/or information, such as meta data relating to the software product or upgrade, bundled third party software components, installation programs, tutorials, user manuals and/or other documentation regarding the software product or upgrade.

The term “upgrade” generally refers to a new release of a software product that is dependent upon a prior release of that product to successfully purchase and/or install.

The phrase “web service” generally refers to an application component that is accessible over open protocols. Web services allow applications to share data and invoke capabilities from other applications. Web services are typically facilitated by the existence of the following features: standard communication protocols, a standard data representation format, standard description languages, and a standard discovery mechanism. Web services may be implemented with various distributed component technologies. An example of a web service is a network accessible service that is designed to be accessed directly by other services or software applications and which interacts programmatically over the network with such services or software applications. According to one embodiment of the present invention, various SDF components are provided as web services that are exposed on the Internet, thereby offering a direct means by which software publisher business processes, such as the release of a new or updated software product, software seller business processes, such as making licenses to software kits available for sale, and enterprise business processes, such as software upgrade and/or installation of a new or updated release of a software product, can interact.

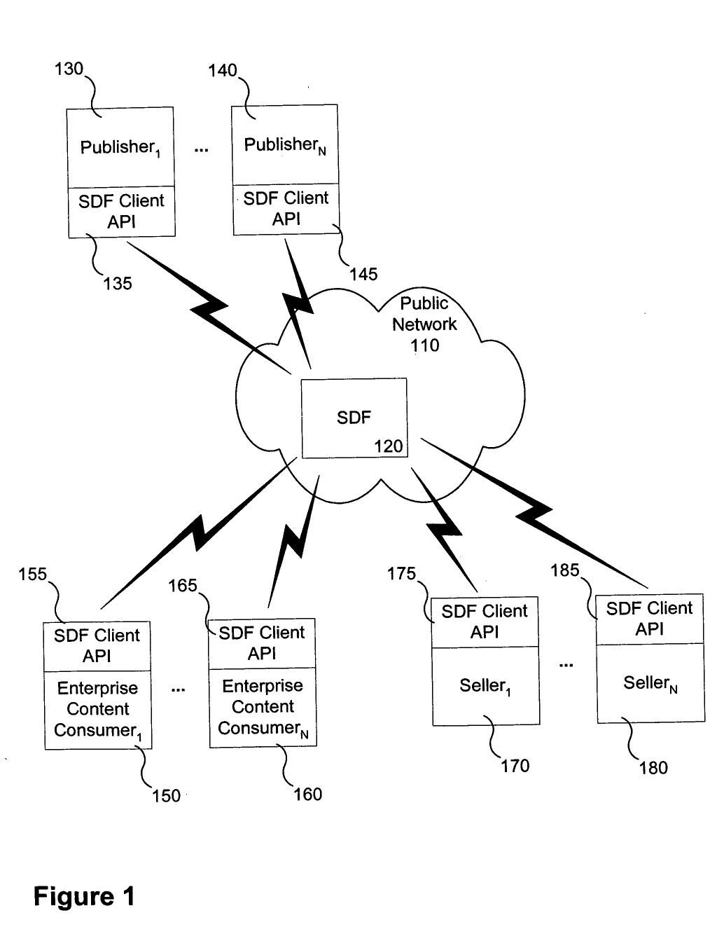

FIG. 1 is a high-level and simplified architectural view of an end-to-end digital content distribution system according to one embodiment of the present invention. In the present example, a software distribution framework (SDF) 120 resides within a public network 110, such as the Internet. As will be described further below, functionality of the SDF 120 may be implemented internally to the SDF 120 and/or distributed among various SDF client application programming interfaces (APIs) 135, 145, 155, 165, 175 and 185 co-located with associated participants in the SDF 120. In the present example, participants in the SDF include a plurality of publishers 130 and 140, a plurality of sellers 170 and 180, and a plurality of enterprise content consumers 150 and 160. It should be noted, that to the extent enterprise content consumers 150 and 160 are associated with the same enterprise, they may interact with the SDF 120 via the same SDF client API.

While the methodologies and architecture described herein are generally applicable to various types of end-to-end digital content distribution systems, without loss of generality various examples described herein are described in connection with the digital distribution of software. According to one embodiment, the SDF 120 serves as an electronic conduit for the dissemination of software product and licensing information. The SDF 120 seeks to remove deployment resistance associated with software upgrade cycles in enterprises by facilitating the fast, flexible, automated and secure distribution of software from publishers, such as publishers 130 and 140, to enterprises and enterprise end users, such as enterprise content consumers 150 and 160. Rather than disjointed, partial solutions, such as those currently provided by software publishers or VARs/LARs, according to one embodiment, the SDF 120 defines an open framework that allows entities that participate in today's software distribution channels to focus on their core competency by simply plugging into the framework and delivering their service as part of the overall software distribution value chain. The SDF 120 may support and enable a wide variety of distribution mechanisms and licensing models. Individual components (described further below) of the SDF 120 may perform all of the heavy lifting associated with tying together software distribution, software licensing, and authentication/authorization. According to one embodiment, the SDF 120 is implemented as a set of components, such as web services, that expose their definitions and interfaces to participants through the Internet to allow such participants to interact with the components with SOAP messages, for example.

According to one embodiment, participants in the SDF 120 first register with the SDF 120. After registering with the SDF 120, publishers 130 and 140 may make new content available to other participants in the SDF 120 by storing the new content, such as software kits or upgrades, within the SDF 120. Authorized sellers 170 and 180 may then sell access and/or licenses to the content to registered enterprises.

In the present example, all interactions with the SDF 120 on the part of participants is orchestrated by way of their respective SDF client APIs 135, 145, 155, 165, 175 and 185. In this manner, the internal structure, organization, and interfaces with SDF components may be abstracted from the participants. Additionally, business logic specific to particular participants in the SDF 120, such as control of software license usage, software license allocation and administration, software installation and entitlement, and approval of new software license purchases, may be preserved thereby allowing flexibility in the way each participant interacts with the SDF 120. Furthermore, the customizable interfaces with the SDF 120 allow the software distribution mechanisms described herein to be integrated with legacy software procurement mechanisms employed by enterprises.

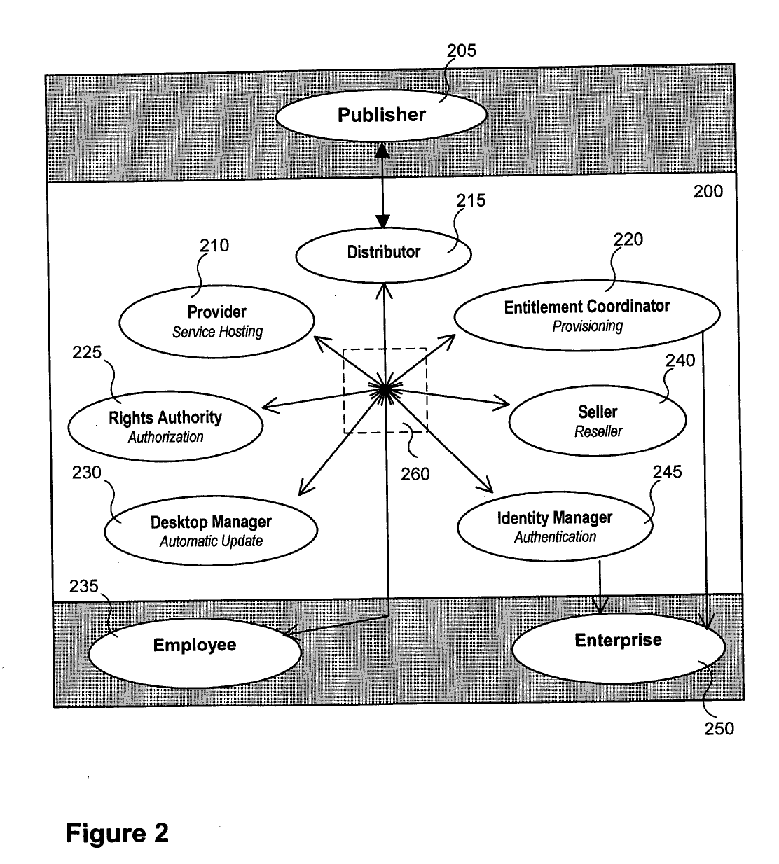

FIG. 2 conceptually illustrates various roles that may participate in a software distribution framework (SDF) 200 and components/services that may facilitate interactions among the various roles according to one embodiment of the present invention. According to the example software distribution framework architecture depicted, entities serving various roles, such as publisher 205, distributor 215, provider 210, seller 240, enterprise 250, and employee 235 (e.g., enterprise user), invoke the capabilities of a set of web services, such as an identity manager 245, a rights authority 225, an entitlement coordinator 220, and a desktop manager 230. As mentioned above, interactions between SDF participants and the various components of the SDF 200 may be orchestrated by a client-side API and set of library services 260.

Entities operating or serving as publishers, such as publisher 205, may create and provide digital content for consumption by other participants in the SDF 200. In the context of software distribution, publishers are responsible for adding new software, such as software kits and upgrades, into the SDF 200. There can be many publishers within the SDF 200. Alternatively, an SDF may be exclusive to a particular publisher or class of software products.

To facilitate distribution, when making new software available via the SDF 200, the publishers typically also provide a description of the software product and licensing options that are available for the software product. For example, the publisher 205 typically provides meta and marketing information that define, among other things: what the software product is; what environment(s) the software product runs in; how the software product relates to other software products; what licensing programs/options are available for the software product, how the available licensing programs/options relate to existing licensing programs/options; and what the price points are within in each licensing program/option.

In the context of the present example, publishers may manage control over which sellers, such as seller 240, and providers, such as provider 210, have the right to sell and/or provide access to their software products. According to one embodiment, publishers may configure access rights relating to their software products via the rights authority 225 web service as described further below.

The function of the distributor role 215 in the context of the SDF is to accept software kits from publishers and make these kits available to providers, sellers and enterprise users. According to one embodiment, only one entity may serve the role of distributor within the SDF 200. In alternative embodiments, however, multiple distributors may participate within the same SDF. Furthermore, in some embodiments, publishers may choose to operate in dual roles as both publishers and distributors

As will be described further below, the distributor 215 may make use of the rights authority 225 to determine access rights of participants registered with the SDF 200. For example, the distributor 215 may query the rights authority 225 regarding: a seller's ability to sell a particular software kit; a provider's ability to host particular software; and an enterprise's ability to download software and make it available to its enterprise users.

The function of the provider role 210 in the context of the SDF 200 is to establish a managed environment where software is hosted in a Software-as-a-Service model. According to one embodiment, providers obtain access to the hosted software by integrating, via web services, with one or more distributors and/or publishers. Alternatively, publishers, such as Independent Software Vendors (ISVs), may operate in dual roles as both publishers and providers. Also, rather than offering access to software applications directly, publishers may offer access to their software products in conjunction with one or more third party Application Service Providers (ASPs).

As will be described further below, the provider 210 may make use of the rights authority 225 to determine access rights of participants, such as enterprises and enterprise users, registered with the SDF 200. For example, the provider 210 may limit which enterprises are able to obtain access to hosted software. Providers may also integrate with or otherwise make use of the entitlement coordinator 220 to provide finer grained access control, e.g., enterprise user-level access control, to hosted software. According to one embodiment, there can be many providers within the SDF 200. It is contemplated, however, that a single provider might exclusively provide access to hosted software within a SDF.

The function of the seller role 240 in the context of the SDF 200 is to sell software kits on behalf of publishers to enterprises, enterprise users, providers or other end users. Typically, sellers work as intermediaries between enterprises and publishers. The seller 240 may also create and define product catalogs and product licensing options and make product pricing available to providers and enterprise users. As mentioned above, publishers may specify access rights for their software products via the rights authority 225. The access rights may identify what software sellers are allowed to sell on behalf of the publisher 205. The seller 240 may also interact with the rights authority 225 as described further below to update the access rights of customers of the seller 240. For example, a seller may update access rights within the rights authority 225 on behalf of an enterprise relating to a software product purchased by the enterprise from the seller 240. Typically, sellers do not take possession of the software, but rather work as the vehicles through which enterprises can get access to software kits. However, the SDF 200 is not constrained to such a model. According to one embodiment, there may be many sellers within the SDF 200. It is contemplated, however, that a single seller might have an exclusive relationship with a particular producer or SDF.

According to one embodiment of the present invention, all participants, e.g., components, web services and entities, such as an enterprise, in the SDF 200 are registered with the identity manager 245 to facilitate authentication during subsequent sessions. For example, the identity manager 245 may serve as a credentialing authority that may issue an object or token to registered participants in the SDF 200 that may be used as an identity credential to obtain access to other components of the SDF 200. In such an embodiment, all enterprises, publishers, sellers, providers, distributors, entitlement coordinators, and desktop managers may register with the identity manager to, among other things, receive an identity credential before they are permitted to begin making use of other services provided by the SDF 200. In one embodiment, sellers and/or entitlement coordinators may perform this registration function on behalf of an enterprise.

Depending upon the level of security desired, the registration process may include obtaining a certificate for use in connection with encrypting sensitive data on the registrant's behalf. Depending upon the type of registrant, additional information may also be obtained. For example, according to one embodiment, enterprises may specify a process that can be used by the identity manager 245 to allow the identity manager 245 to authenticate enterprise users associated with the particular enterprise. Various options for specifying the process include, but are not limited to: (1) the enterprise 250 defining a web service within the enterprise that the identity manager 245 may call to perform the authentication; (2) the enterprise 250 making use of an outside web service which will take in data regarding enterprise users from the enterprise 250; or (3) the enterprise 250 defining an XML feed process whereby the enterprise 250 transmits, e.g., via File Transfer Protocol (FTP), XML formatted enterprise user data to the identity manager 245 or a data store accessible to the identity manager 245. Additionally, participants in the SDF 200 may add additional fields to the user data that they can use to store user attributes specific to their needs. For example, a role may be associated with the employee 235 to allow component logic to distinguish among various types of end users.

The rights authority 225 is responsible for performing authorization processing within the SDF 200 and deciding which providers, sellers, and enterprises have access rights to the software contained within the SDF 200. According to one embodiment, only one rights authority 225 may be associated with the SDF 200. Alternatively, multiple rights authority web services may be provided that access a single managed data source containing access rights information.

According to one embodiment, for enterprises, access rights maintained by the rights authority 225 are not kept at the enterprise user level, but rather at the enterprise level itself. Additionally, the rights authority 225 need not enforce or control license compliance of enterprises, but rather only the ability to download the software kit itself. Limits can be place on the number of times the enterprise 250 may download a particular software kit.

According to one embodiment, for providers, the rights authority 225 may only determine which enterprises have the right to access the software kit. For example, in the SDF architecture of the present example, the rights authority 225 does not determine the manner in which the enterprise users are entitled use of or access to the software. According to the present example, the provider 210 makes use of the entitlement coordinator 220 to determine such fine-grained level of access. In alternative embodiments, however, functionality of the entitlement coordinator 220 may be integrated with the rights authority 225.

According to one embodiment, the role of the entitlement coordinator 220 in the SDF 200 is to provide a more fine-grained level of control over which enterprise users within the enterprise 250 are entitled to access and use the software contained within the SDF 200. When employed, the entitlement coordinator 200 allows the enterprise 250 to define a customized workflow for enterprise user software entitlement. Customization of this workflow may include calls to enterprise-defined web services.

If the enterprise 250 makes use of the provider 210, the provider 210 may be directed to use the entitlement coordinator 220 to limit access to the enterprise's hosted software. While there may be many entitlement coordinators within an SDF, ideally to reduce the complexity of managing the entitlement information, an individual enterprise should subscribe to only one.

The function of the desktop manager role 230 in the context of the SDF is to keep enterprise user's desktops up-to-date with the latest versions of software to which they are entitled. According to one embodiment, the desktop manager 230 periodically pulls new software kits from the distributor 215, on the enterprise's behalf, and pushes the new software kits to the enterprise 250. Alternatively, with smart clients, the new software kits may be pushed directly to the enterprise user's desktop. As in this case of entitlement coordinators, while there may be many desktop managers within an SDF, ideally to reduce complexity, an enterprise would generally subscribe to only one. In SDF implementations having an entitlement coordinator role, the desktop manager 230 makes use of the entitlement coordinator 220 to determine the software to which enterprise users have access.

Enterprises, such as enterprise 250, are organizations that purchase software licenses, directly or indirectly, from themselves, publishers (potentially via a seller 240). Depending upon the SDF implementation, an enterprise's licenses can be maintained directly by the publisher 205 or, managed on behalf of the enterprise 250 by the seller 240. According to one embodiment, an enterprise's identity, e.g., a unique Uniform Resource Identifier (URI), is assigned by and persisted within the identity manager 245 along with other enterprise specific data which will be discussed further below, such as a public key associated with the enterprise 250. According to the SDF architecture of the present example, enterprises may obtain access to their licensed software: (1) through their seller's web site (if the seller 240 provides this capability); (2) through the provider 210; (3) through the entitlement coordinator's web site (again, assuming the entitlement coordinator 220 provides this capability); (4) through the distributor 215; and/or (5) through one of other web services that may be provided by the SDF 200.

Enterprise users, such as employee 235, are individuals that are part of an enterprise. Enterprise users may be entitled to use one or more software products purchased by their enterprise. According to one embodiment, enterprise-user-level access to enterprise purchased software is managed via the entitlement coordinator 220. In such an embodiment, the distributor 215 and rights authority 225 manage access to software kits at the enterprise level. Alternatively, as mentioned earlier, the roles of entitlement coordinator 220 and rights authority 225 may be merged. Regardless, audits of download activity can include enterprise user level details.

Note that in the above description, in order to facilitate explanation, the SDF components were discussed without reference to physical location and independent of machine and/or device associations. Depending upon the particular implementation, the business and/or component logic of various SDF components may be implemented within one or more entities that participate in the SDF or may reside within the public network cloud. For example, the rights authority 225 may be a web service running within and managed by the publisher 205, the desktop manager 230 may reside within the enterprise 250, etc. In an enterprise-hosted implementation of the SDF 200, the rights authority 225, desktop manager 230, entitlement coordinator 220, and identity manager 245 may all reside within the enterprise 250. Various other component distributions are possible.

It is contemplated that the SDF components may each comprise multiple physical and/or logical devices connected in a distributed architecture. Alternatively, one or more of the SDF components may be co-located. The functions performed by the various SDF components may also be consolidated and/or distributed differently than as described and the processes described may be consolidated onto one machine or may be divided across multiple machines. Any function can be implemented on any number of machines or on a single machine and various roles may be combined or further broken apart. For example, the roles of rights authority 225 and entitlement coordinator 220 may be combined into a single role. Finally, it is contemplated that various roles may not be required or that additional roles may be added to accommodate various usage scenarios.

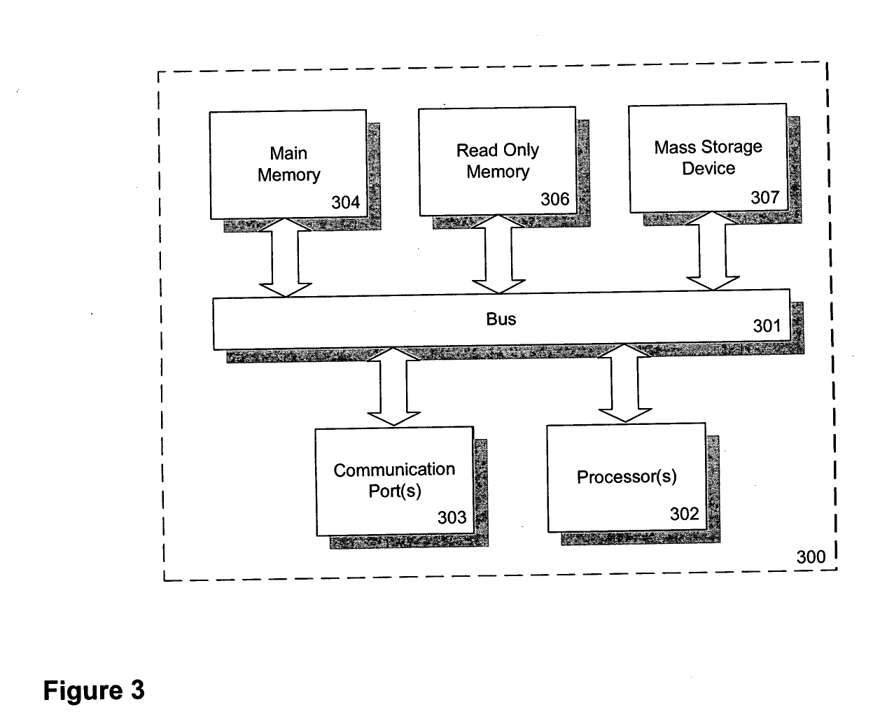

FIG. 3 is an example of a computer system 300 with which embodiments of the present invention may be utilized. Computer system 300 represents an exemplary client system or server system from which enterprise users may initiate interactions with the SDF 200 or upon which one or more SDF components may run, respectively. In this simplified example, the computer system 300 comprises a bus 301 or other communication means for communicating data and control information, and one or more processors 302, such as Intel® Itanium® or Itanium 2 processors, coupled with bus 301.

Computer system 300 further comprises a random access memory (RAM) or other dynamic storage device (referred to as main memory 304), coupled to bus 301 for storing information and instructions to be executed by processor(s) 302. Main memory 304 also may be used for storing temporary variables or other intermediate information during execution of instructions by processor(s) 302.

Computer system 300 also comprises a read only memory (ROM) 306 and/or other static storage device coupled to bus 301 for storing static information and instructions for processor(s) 302.

A mass storage device 307, such as a magnetic disk or optical disc and its corresponding drive, may also be coupled to bus 301 for storing instructions and information, such as configuration files, a key store and registration database, etc.

One or more communication ports 303 may also be coupled to bus 301 for supporting network connections and communication of information to/from the computer system 300 by way of a Local Area Network (LAN), Wide Area Network (WAN), the Internet, or the public switched telephone network (PSTN), for example. The communication ports 303 may include various combinations of well-known interfaces, such as one or more modems to provide dial up capability, one or more 10/100 Ethernet ports, one or more Gigabit Ethernet ports (fiber and/or copper), or other well-known network interfaces commonly used in internetwork environments. In any event, in this manner, the computer system 300 may be coupled to a number of other network devices, clients, and/or servers via a conventional network infrastructure, such as an enterprise's Intranet, server farm and/or the Internet, for example.

Optionally, operator and administrative interfaces (not shown), such as a display, keyboard, and a cursor control device, may also be coupled to bus 301 to support direct operator interaction with computer system 300. Other operator and administrative interfaces can be provided through network connections connected through communication ports 303.

Finally, removable storage media (not shown), such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 301 via corresponding drives, ports or slots.

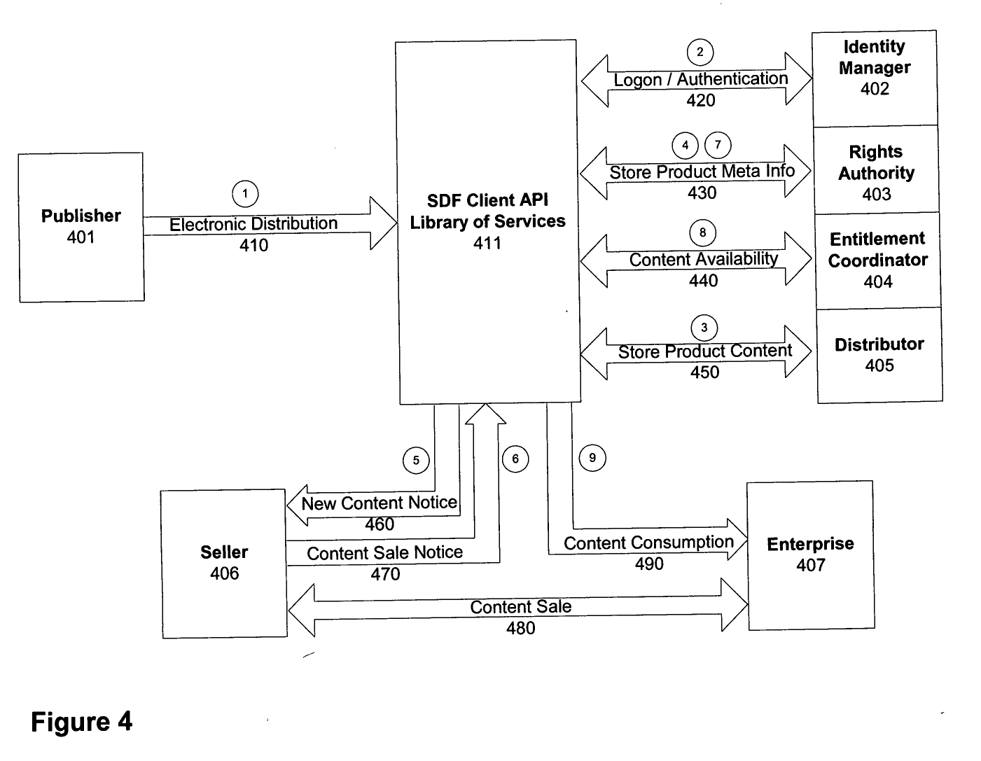

FIG. 4 conceptually illustrates high-level interactions among components and participants in a software distribution framework to accomplish end-to-end electronic software distribution from a publisher 401 to an enterprise 407 according to one embodiment of the present invention. For purposes of explanation, in the present example, interactions among participants in the SDF and components of the SDF are described at a high-level. Further details regarding internal processing performed by various participants and SDF components are provided below.

In the present simplified, high-level example, participants in the SDF include the publisher 401, a distributor 405, a seller 406, and the enterprise 407. SDF components involved in the end-to-end distribution of software in the present example include an identity manager 402, a rights authority 403, and an entitlement coordinator 404. For convenience, in the present example, a SDF client API library of services 411 represents, collectively, the SDF client APIs that may be individually associated with each of the participants in the SDF.

The publisher 401 performs electronic distribution 410 of a software kit or upgrade by invoking one or more methods provided by the SDF client API library of services 411. The SDF client API library of services 411 in turn orchestrates appropriate interactions with the SDF components to make the software kit or upgrade available via the SDF.

In the current example, it is assumed the publisher 401 does not have an active session established with the SDF. Consequently, the SDF client API library of services 411 first establishes a session with the SDF by performing logon/authentication processing 420 with the identity manager 402.

After a session has been established between the publisher 401 and the SDF, the SDF client API library of services 411 proceeds to store product content 450 with the distributor 405. In addition to the digital content representing the software kit or the upgrade, the distributor 405 may also store information associated with the software kit or upgrade. For example, the distributor 405 may maintain a catalog of available software kits and/or upgrades containing information regarding (1) a unique identifier supplied by the publisher 401 to represent the software kit or upgrade, such as a manufacturer SKU; (2) a unique identifier associated with the publisher 411, such as a URI assigned to the publisher 401 by the SDF; (3) identification, such as a URI, of one or more authorized sellers; and (4) licensing terms, such as pricing and licensing constraints.

The SDF client API library of services 411 may also store product meta information 430 with the rights authority 403. Meta information may include identification of sellers having authorization to sell licenses to the software kit or upgrade on behalf of the publisher 401, enterprises having authorization to access the software kit or upgrade, and the number of licenses available to the authorized enterprises. In the case of a new software kit, initially no enterprise users may be authorized to access the new software kit. However, in the case of an upgrade, authorization may be initially granted to enterprises having paid up and valid maintenance contracts in place. Consequently, according to alternative embodiments, rather than or in addition to storing product meta information with the rights authority 403 responsive to a new software kit or upgrade being added to the SDF, such meta information may be stored responsive to a sale of the software kit or upgrade to the enterprise 407.

In response to a new software kit or upgrade being made available for distribution by the publisher 401, the SDF client API library of services 411 also provides a new content notice 460 to authorized sellers, such as seller 406, of the new software kit or upgrade.

After a content sale 480 has been completed for a particular software kit or upgrade, the seller 406 provides a content sale notice 470 to the SDF by invoking one or more methods provided by the SDF client API library of services 411. The SDF client API library of services 411 initializes or updates the enterprise authorization information in the rights authority 403 to enable access by enterprise users of the enterprise 407 to the software kit or upgrade in accordance with the number of licenses purchased by the enterprise 407. Depending upon the implementation, the authority of the seller 406 to sell the particular software kit or upgrade may be verified by the enterprise 407 by inquiring with the rights authority 403 before initiating the purchase transaction with the seller 406.

If information regarding enterprise-user-level access authorization or constraints is provided by the enterprise 407 to the seller 406 contemporaneously with the purchase of the software kit or upgrade, then the SDF client API library of services 411 may initialize or update content availability 440 with the entitlement coordinator 404. Alternatively, such information regarding enterprise-user-level entitlement to software kits and/or upgrades may be provided separately and/or at a later time through an appropriate administrative interface at the enterprise 407.

Finally, enterprise users of the enterprise 407 that are so entitled may perform content consumption 490 by downloading a software kit or upgrade for which one or more licenses has been purchased by the enterprise 407. Again, the foregoing description of high-level interactions among the participants in the SDF and the SDF components is not intended to be comprehensive, but rather provide context for the more detailed usage scenarios and flows described below.

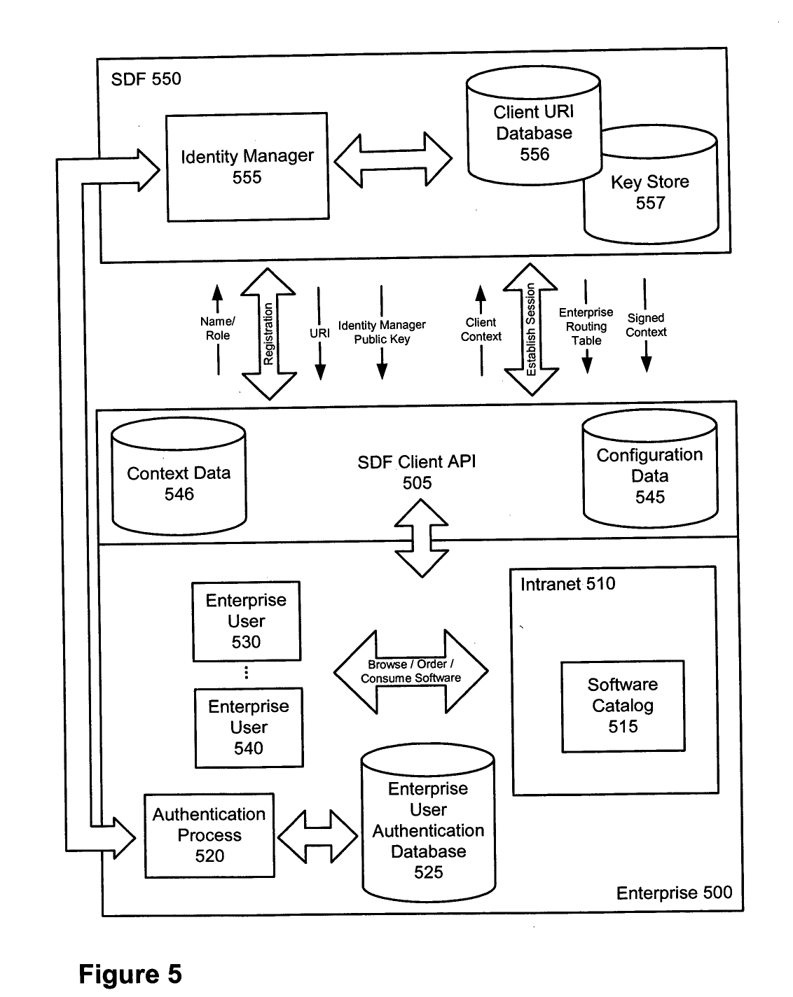

FIG. 5 conceptually illustrates interactions between an identity manager 555 and an enterprise 500 during client registration and client session establishment according to one embodiment of the present invention. According to the present example, enterprise users 530 and 540 may browse and/or order software to which they are entitled through a software catalog 515 made available via the enterprise's intranet 510. When enterprise users 530 and 540 establish a session with the SDF 550 (also referred to herein as “user sessions”), the identity manager 555 may authenticate the identity of the user and verify the user's affiliation with the enterprise 500. The enterprise 500 provides the identity manger 555 access to an enterprise user authentication database 525 via an authentication process 520, such as an application program or stored procedure. Information, such as user name and role, regarding enterprise users, such as enterprise users 530 and 540, that are authorized to access the SDF 550 may be stored in the enterprise user authentication database 525 to enable the authentication process 520 to respond to authentication requests by the identity manager 555.

Interactions between the SDF 550 and the enterprise 500, such as registration and session establishment with the identity manager 555, are coordinated via an intermediate SDF client API 505. Data stores employed by the SDF client API 505 to facilitate such interactions with the identity manager 555 and other SDF components include context data 546 and configuration data 545. According to one embodiment, configuration data 545 includes a public key associated with the SDF client API 505 (also referred to herein as the “client public key”), the Uniform Resource Locator (URL) to the identity manager, and a list of local domains identifying the name of the current local machine the SDF client API 505 is running on. As discussed below, during an automated registration process with the SDF 550, a URI may be assigned to the SDF client API 505 (also referred to herein as the “client URI”) and the public key associated with the identity manager 555 may be provided to the SDF client API 505. However, in embodiments in which registration with the SDF 550 is not fully automated, the client URI and the public key of the identity manager 555 may be predefined within the configuration data 545.

According to one embodiment, the context data 546 includes a context object associated with the SDF client API 505 (also referred to herein as the “client context”) and context objects associated with enterprise users 530 and 540 (also referred to herein as “user contexts”). The client context contains, among other data, the client public key, the client URI, a digital signature of the identity manager 555, a certificate associating the SDF client API 505 with the client public key, the public key of the identity manager 555, and a routing table containing information regarding routes to SDF components, such as a URL, a pointer to a web service interface, and/or an indication that the component is local (e.g., running on the same machine as the SDF client API 505 or within the same local area network). The user contexts may include, in addition to the information contained within the client context, identification information associated with the user, such as a user name and a user URI. When signed by the identity manager 555, the contexts represent identity credentials that the SDF client API 505 may use on behalf of the enterprise 500 and/or enterprise users 530 and 540 to interact with the SDF components.

For purposes of simplicity, in the present example, only those portions of the SDF 550 that are involved in SDF participant registration and session establishment are depicted. According to various embodiments in which the registration process with the SDF 550 is automated, the SDF client API 505 submits a registration request to the identity manager 555 by communicating the name of the enterprise 500 and identifying the role the enterprise 500 would like to play within the SDF 550. Assuming access is to be granted to the enterprise 500, in response to the registration request, the identity manager 555 generates a URI to uniquely identify the enterprise 500 within the SDF 550, adds the enterprise to the client URI database 556, and returns the newly assigned URI and the public key of the identity manager 555 to the SDF client API 505. Enterprise users 530 and 540 may also be assigned URIs by the SDF 550.

According to the present example, when the SDF client API 505 establishes a session with the SDF 550 on behalf of the enterprise 500 (referred to herein as a “client session”), the SDF client API 505 submits a session establishment request to the identity manager 555 and includes the context 546 as part of the request. Upon successful establishment of the requested client session, the identity manager 555 returns to the SDF client API 505 a signed context and a routing table. The client session may be established in accordance with a predetermined schedule or on as-needed-basis responsive to interactions with the SDF initiated by one of the enterprise users 530 and 540. During the client session, individual user sessions may be established and maintained in a similar manner. Further details regarding exemplary session establishment processing are described below.

According to one embodiment, user-level sessions with the SDF support the ability to provide certain users with administrative or privileged functions. For example, a web-based portal may be developed on top of the SDF and within such a portal, admin functions may then be granted to users within the context of an enterprise to allocate software product licenses, for example. In other embodiments, user-level sessions enable an entitlement coordinator to authorize access to software at a user-level.

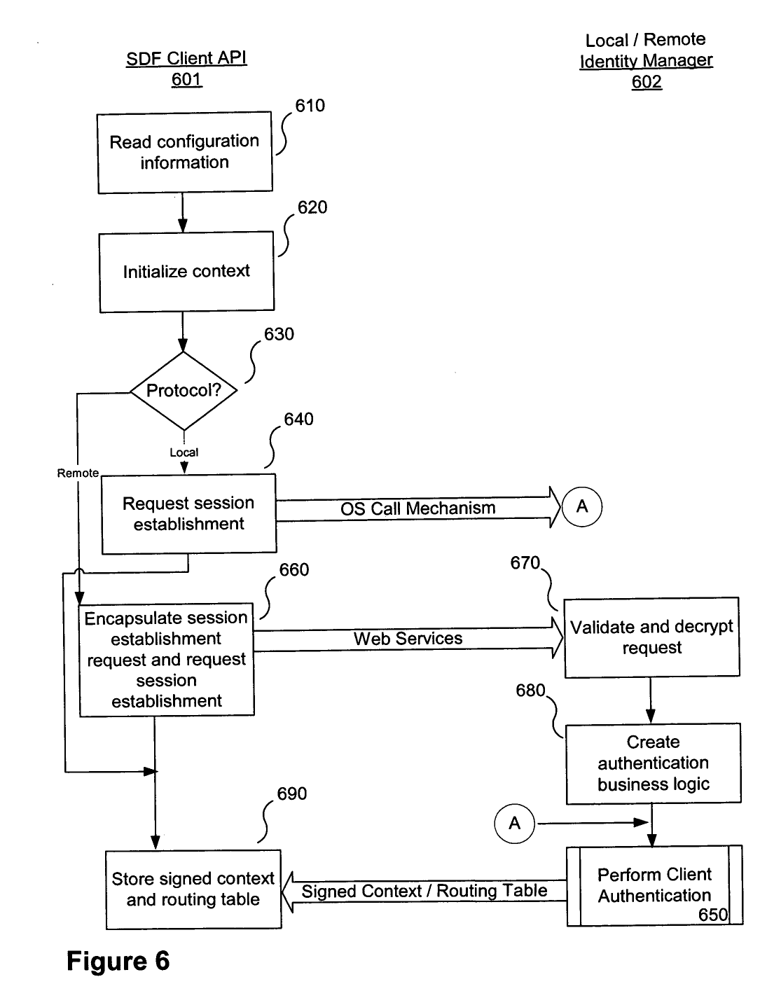

FIG. 6 is a flow diagram illustrating client session establishment processing according to one embodiment of the present invention. According to the present example, it is assumed that SDF client API 601 is associated with a registered participant in a SDF. Session establishment begins at block 610 with the SDF client API 601 reading configuration information from an appropriate configuration file. Depending upon the particular implementation, the configuration information may include one or more of the following: a public key for the identity manager 602, a URL to the identity manager 602, the client public key, a session timeout length for both the client session and any future user sessions, a list of local domains identifying the name of the current local machine the SDF client API 601 is running on.

At block 620, the SDF client API 601 initializes the client context object by including therein information regarding the client URI, the client public key (e.g., the value of the key or an indication of where such key can be obtained) and the public key of the identity manager 602.

At decision block 630, a determination is made regarding the message passing protocol to be used to interact with the identity manager 602. According to one embodiment, the identity manager 602 may be local (e.g., running on the same machine as the SDF client API 601) or remote (e.g., running on a different machine than the SDF client API 601). The determination regarding the type of message passing to use may involve comparing the list of local domains to the domain name specified in the URL of the identity manager 602. If the identity manager 602 is determined to be local, then processing continues with block 640; otherwise, processing continues with block 660.

At block 640, the SDF client API 601 has determined that the identity manger 602 is local and performs appropriate message passing to request session establishment with the local identity manager 602. When the identity manager 602 and the SDF client API 601 are running on the same machine, operating system call mechanisms, such as RPC, ORPC or COM, may be used to invoke a method of the identity manager 602 to establish a session with the SDF.

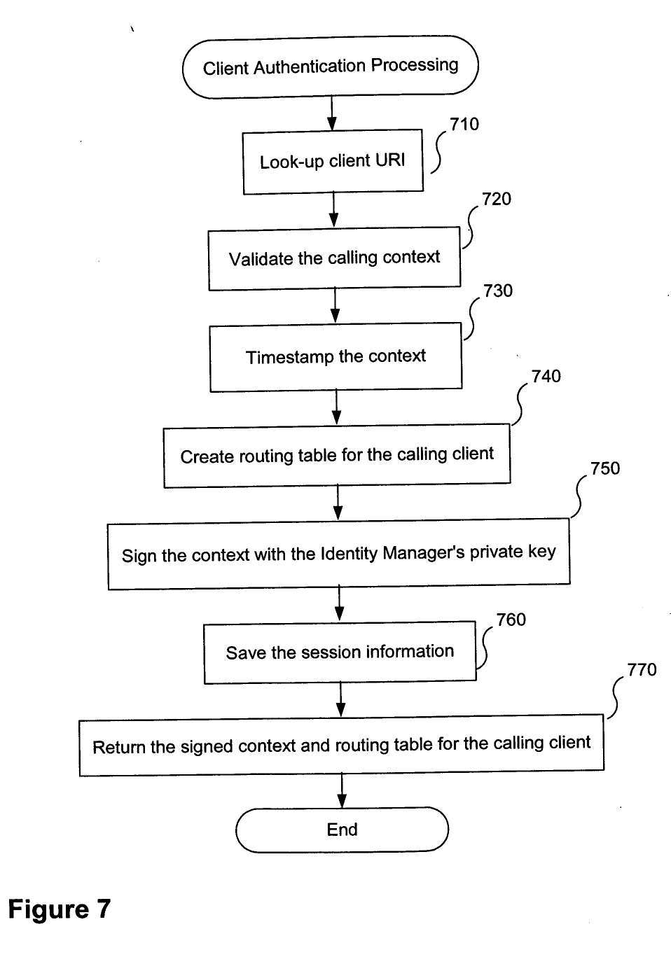

At block 650, the identity manager 602 responsive to the local or remote SDF client API 601 session establishment request performs client authentication processing to establish the identity of the requester as a registered SDF participant. Client authentication processing according to one embodiment of the present invention is described further with reference to FIG. 7.

At block 660, the SDF client API 601 has determined that the identity manger 602 is remote and performs appropriate message passing to request session establishment with the remote identity manager 602. According to present example, when the identity manager 602 is remote from the SDF client API 601, the SDF client API 601 uses web services to request session establishment with the identity manager 602. First, the SDF client API 601 encapsulates the session establishment request within an appropriate web services messaging framework, such as a SOAP message. For security, the SDF client API 601 may encrypt the entire SOAP request with the public key of the identity manager 602 and may also sign the entire SOAP request with a private key associated with the SDF client API 601 (also referred to herein as the “client private key”) and add the signature to the SOAP header. Finally, the SDF client API 601 uses an Internet transfer protocol, such as HyperText Transfer Protocol (HTTP), to transfer the SOAP request representing the session establishment request to the remote identity manager 602.

At block 670, responsive to receipt of the session establishment request from the SDF client API 601, the identity manager 602 validates the signed request using the caller's public key and if the request is determined to have been originated by the purported caller and not to have been tampered with, then the identity manager 602 proceeds to decrypt the request using it's private key. According to one embodiment, the identity manager 602 stores a local copy of all registered participants with the SDF in a local key store database indexed by the participant's URI.

At block 680, appropriate authentication business logic is created, for example, by creating an instance of an identity manager business logic class, which includes a client authentication method. Flow then proceeds to block 650 where the client authentication method is invoked by the identity manager 602.

At block 690, the SDF client API 601 receives from the local or remote identity manager 602 a signed context and a routing table. In the case of a remote identity manager 602 returning information via web services in the form of a signed SOAP response, the SDF client API 601 validates the signed response using the remote identity manager's public key and if the response is determined to be from the identity manager 602 and not tampered with, then the SDF client API 601 decrypts the response with the client private key. In the case of either a remote or local identity manager 602, the signed context and routing table are stored by the SDF client API 601 for use as an identity credential during subsequent interactions with SDF components and to determine whether such SDF components are local or remote, respectively.

In alternative embodiments, at decision block 630 finer levels of granularity than simply local vs. remote may be employed to influence the type and characteristics of message passing between the SDF client API 601 and the identity manager 602. According to one embodiment, if it is determined that the SDF client API 601 and the identity manger 602 are running within the same local area network, then fewer security measures may be employed in connection with the message passing between the SDF client API 601 and the identity manager 602. For example, when the SDF client API 601 and the identity manager 602 reside behind the same firewall, increased efficiency in message passing may be achieved by foregoing message encryption and/or digital signature processing.

As should be apparent, various processing blocks described above may be performed in an order other than depicted. For example, the local/remote protocol decision of decision block 630 is independent of the state of the client context object and as a result block 620 may be performed after block 630.

FIG. 7 is a flow diagram illustrating identity manager client authentication processing according to one embodiment of the present invention. At block 710, the identity manager looks up the URI of the client. According to one embodiment, the identity manager maintains a client URI database containing the URI for each registered participant in the SDF. In such an embodiment, the identity manger may query the client URI database to determine whether the client is registered with the SDF.

At block 720, the identity manager validates the calling context. According to one embodiment, the calling client digitally signs the context with its private key. Consequently, the identity manager may confirm the identity of the caller and verify the context was not tampered with by creating a message digest of the context using the same hashing algorithm as used by the client and comparing it to the message digest resulting from applying the client's public key to the digital signature. Assuming the validity of the calling context, at block 730, the context may be timestamped to allow the SDF to monitor the age of the client context during subsequent requests and permit periodic renewal of this identity credential device.

At block 740, the identity manager creates a routing table for the client. According to one embodiment, the routing table consists of the locations of all of the SDF components. In an SDF environment in which one or more SDF components may be local and one or more SDF components may be remote, the routing table allows the SDF client API to select an appropriate message passing mechanism for communicating with the various SDF components.

Rather than including locations of all of the SDF components, in an alternative embodiment, the routing table may be tailored to include only a customized list of those of the SDF components representing the specific business partners of the client. For example, if there were five seller components registered with the SDF, the customized list could be limited to include only those sellers that the caller has identified as being one of its business partners. In one embodiment, the routing table includes both the complete list of locations of all of the SDF components and a customized list of only those SDF components that are business partners of the caller. In an SDF environment in which all SDF components are known to be either local or remote, a routing table may not be used. At any rate, assuming the use of a routing table as is the case in the present example, the identity manager may store the routing table within the newly created context for the caller.

At block 750, the identity manager signs the context with its private key. This allows other SDF components to efficiently validate the context with the identity manager's public key during subsequent interactions with the caller and without having to call upon the identity manager to revalidate the context.

At block 760, session information for this newly established client session may be stored by the identity manager in a local database.

At block 770, the identity manager returns the newly created and signed context and the routing table to the calling client and client authentication processing is complete.

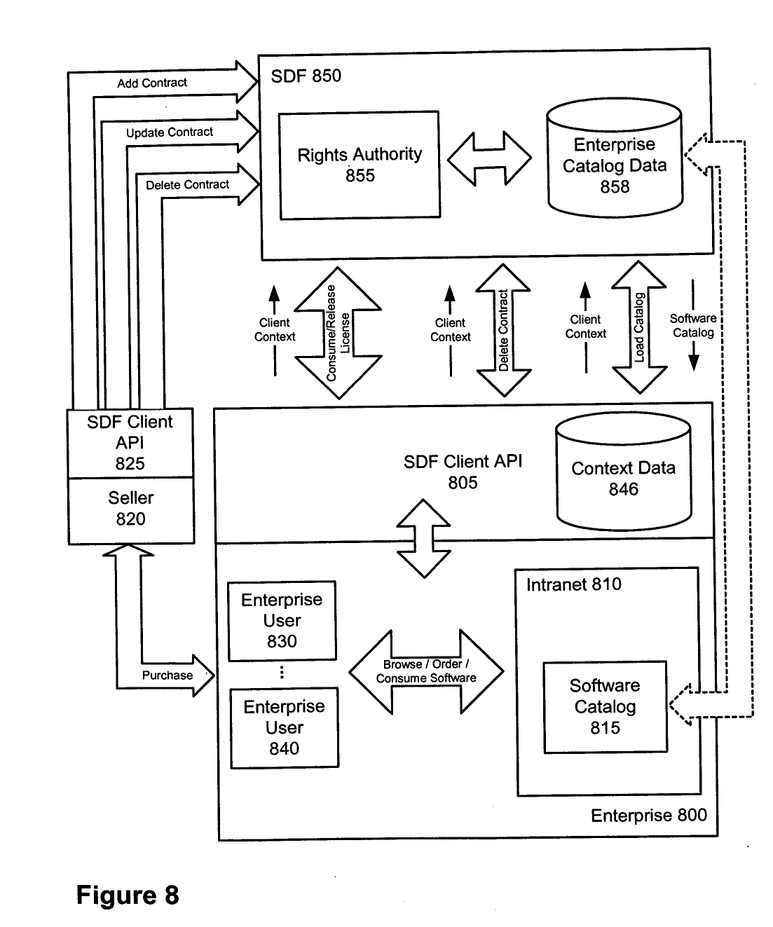

FIG. 8 conceptually illustrates interactions among a rights authority 855, an enterprise 800, and a seller 820 according to one embodiment of the present invention. In the present example, for purposes of simplicity, certain interactions among participants in the SDF and components of the SDF are described at a high-level. For example, local context data stored within the SDF client API 825 of the seller 820 is not shown or described and parameters and return values of certain message passing scenarios, such as the add contract flow, update contract flow and delete contract flow between the SDF client API 825 of the seller 820 and the rights authority 855 are neither shown nor described. Further details regarding internal processing performed by the SDF client API 825 and the rights authority 855 are provided below.

According to the present example, the enterprise 800 purchases software licenses from the seller 820 either directly or via SDF 850 supplied mechanisms. Regardless of the method of purchase, the seller 820 adds information to the SDF 850 regarding the new software contract to make the licensed software available to enterprise users 830 and 840 via the SDF 850. In one embodiment, the add contract messaging from the SDF client API 825 to the rights authority 855 provides sufficient information to the rights authority 855 regarding the new enterprise/seller contract to allow the rights authority 855 to authorize access to appropriate software kits in response to access requests from enterprise users, such as enterprise users 830 and 840. Generally, the enterprise catalog data 858 contains information for each registered enterprise regarding the current number of available licenses to software kits that were purchased from a registered seller. An example of the type of information that may be provided from the seller 820 to the rights authority 855 and stored within the enterprise catalog data 858 is described further below.

According to the example depicted, the seller 820 may notify the rights authority 855 of modification, cancellation, termination, expiration or other event triggering change of access rights to software kits at issue via the update contract messaging or the delete contract messaging from the SDF client API 825 to the rights authority 855.

After the enterprise 800 has purchased software licenses from the seller 820 for a particular software kit and the rights authority 855 has been informed of the associated enterprise/seller contract, consumption of the software licenses may commence. According to the present example, enterprise users 830 and 840 may browse, order and/or consume software to which they are entitled through a software catalog 815 made available via the enterprise's intranet 810.

Interactions between the enterprise 800 and the SDF 850, such as deleting the contract and loading the catalog of software available to the enterprise, are coordinated via an intermediate SDF client API 805 associated with the enterprise 800. A data store employed by the SDF client API 805 to facilitate such interactions with the rights authority 855 and other SDF component includes context data 846 which maintains information regarding contexts of active client and user sessions with the SDF 850 as described above with respect to FIG. 5.

For purposes of simplicity, in the present example, only those portions of the SDF 850 that are involved in creating, persisting, accessing and/or manipulating enterprise/seller contract information are depicted. According to the present example, enterprise users 830 and 840 may browse, order and/or consume software to which they are entitled through a software catalog 815 made available via the enterprise's intranet 810. Without getting into the details of provisioning a particular enterprise user's workstation, e.g., desktop or laptop computer, with licensed software, when a software license is consumed by an end user, such as end user 830 or 840, the rights authority 855 updates the appropriate enterprise catalog data 858 record corresponding to the license consumed by decrementing the number of licenses that are available to the enterprise 800 for the particular software kit. Similarly, when a software license is released by an end user, the rights authority 855 updates the appropriate enterprise catalog data 858 record corresponding to the released license by incrementing the number of licenses that are available to the enterprise 800 for the particular software kit.

In one embodiment, the enterprise 800 may provide a real-time view of software that is currently accessible to enterprise users 830 and 840 by acquiring a new software catalog from the rights authority 855 responsive to inquiries from enterprise users 830 and 840 relating to the software catalog 815. Alternatively, the software catalog 815 may be periodically refreshed on a daily or other basis.

According to the present example, a new software catalog may be retrieved from the SDF 850 by the SDF client API 805 submitting a load catalog request to the rights authority 855 along with the client context retrieved from the locally stored context data 846. Upon successful retrieval of the requested software catalog, the rights authority 855 returns the catalog of software products that are available to the enterprise 800. According to one embodiment, in addition to identifying information regarding available software products, such as title and publisher, the catalog may include information indicative of one or more of the following: enterprise users that have consumed licenses, total number of licenses purchased by the enterprise 800, and number of licenses remaining available for consumption. Depending upon the SDF implementation and needs of the enterprise, more or less information may be included in the catalog of software products returned from the rights authority 855. Further details regarding exemplary interactions between a seller and the rights authority 855 and between an enterprise and the rights authority 855 are described below.

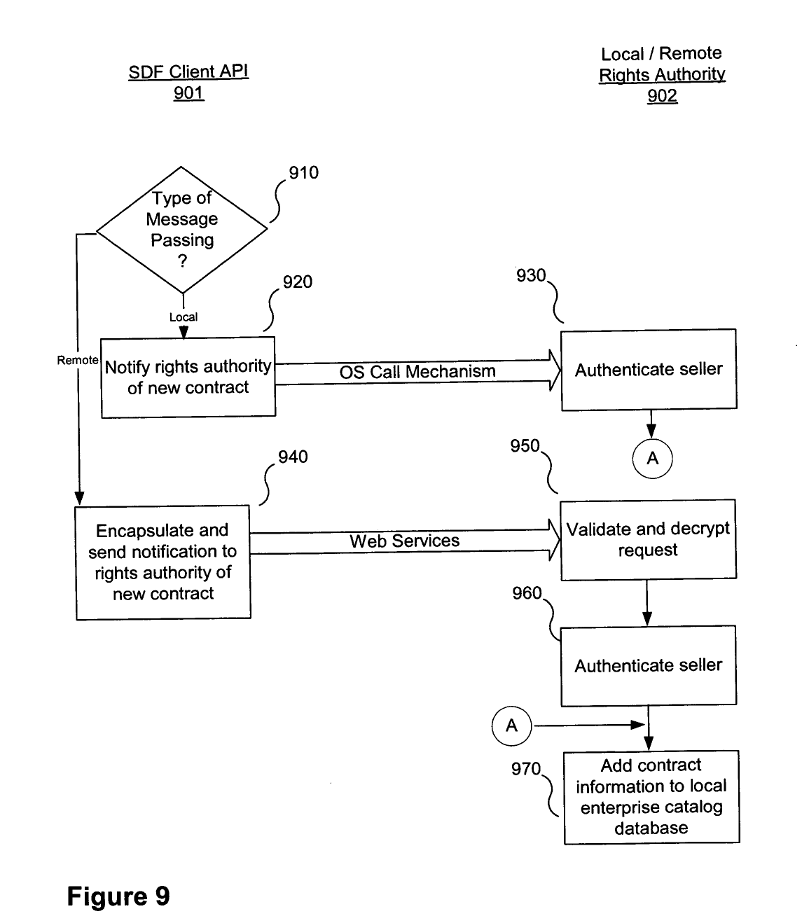

FIG. 9 is a flow diagram illustrating the processing involved in connection with addition of an enterprise/seller contract to a rights authority 902 according to one embodiment of the present invention. According to the present example, it is assumed that SDF client API 901 is associated with a registered seller participant in a SDF and has an active session established with the SDF. It is also assumed that an enterprise/seller contract relating to the purchase of one or more licenses of a software product by an enterprise from the seller has been completed.

The addition of information relating to the enterprise/seller contract begins at decision block 910 with the SDF client API 901 determining the type of message passing to perform in connection with interacting with the rights authority 902. According to the present example and as discussed above, the type of message passing is based upon the logical proximity of the rights authority 902 to the SDF client API 901. If the rights authority 902 is determined to be local based upon a comparison between the known local domains and the domain name of the rights authority 902, then processing continues with block 920. Otherwise, if the rights authority 902 is determined to be remote, then processing continues with block 940.

At block 920, the SDF client API 901 has determined the rights authority 902 is local and performs appropriate message passing to notify the local rights authority 902 of the new enterprise/seller contract. As mentioned earlier, when an SDF component, such as the rights authority 902, and the client, such as the SDF client API 901, are running on the same machine, operating system call mechanisms may be used to invoke methods of the SDF component. In the present example, when the rights authority 902 is local, the SDF client API 901 invokes a method provided by the rights authority 902 to add information regarding a new enterprise/seller contract by supplying an identity credential, such as the context of the seller, and specific information concerning the transaction, the parties to the transaction and the subject matter of the transaction.

In one embodiment, the information regarding the new enterprise/seller contract includes: the URI of the seller, the URI of the publisher of the software product, the manufacturer SKU (e.g., an identifier assigned by the publisher that uniquely identifies the software product), the seller order ID that is used by the seller to track the transaction, the seller order line ID (e.g., a unique line number on the order placed with the seller), an indication of the transaction type, enterprise bill to information (e.g., name, address, department, and other contact information of the company or individual), seller order type, seller order invoice ID (e.g., a unique ID that represents a seller providing a bill to an enterprise), seller order invoice line ID (e.g., a unique line on the invoice representing the order ID), seller order line ID quantity (e.g., a numeric value representing the number of products purchased from seller by the enterprise), enterprise ship to information, and a flag indicating whether the contract is active or not.

At block 930, responsive to the SDF client API 901 request to add information regarding a new enterprise/seller contract to the SDF, the local rights authority 902 authenticates the seller based upon the identity credential supplied by the SDF client API 901. According to one embodiment, the identity credential comprises a client context signed by the identity manager. In such a case, rather than revalidating the context with the identity manager, the rights authority 902 may use the identity manager's public key to validate that the supplied client context was originated by the identity manager.

Additionally, the local rights authority 902 may confirm the role of the caller is that of a seller. The general idea behind confirming the role of the caller is to prevent callers from unintentionally or intentionally invoking functionality that is not applicable to their role. Such additional role validation seeks to increase the security of the system by preventing hijacking of the SDF and/or the initiation of unauthorized processing or retrieval of unauthorized information by participants in the SDF or users attempting to impersonate or masquerade as another role or user. Consequently, while some methods/services, such as session establishment with the identity manager may be invoked/accessed by all SDF participants, other methods/services, such as adding information regarding a new enterprise/seller contract to the rights authority, may be invoked/performed only by a SDF participants operating within a particular role.

Further, in order to verify the client context has not been altered since creation by the identity manager, the rights authority may create a hash of the content of the context, decrypt the signed hash (i.e., the digital signature), and compare the results. If the two hash values do not match, then the context was altered after the identity manager signed it, thereby making the context invalid. Assuming the supplied client context is valid, however, then processing continues with block 970.

At block 940, the SDF client API 901 has determined the rights authority 902 is remote and performs appropriate message passing to notify the remote rights authority 902 of the new enterprise/seller contract. As mentioned earlier, when an SDF component, such as the rights authority 902, is remote from the client, such as the SDF client API 901, interaction between the two may be via web services. As in the case of a local rights authority 902, the SDF client API 901 prepares a request (e.g., a notification) to be communicated to the remote rights authority 902 containing an identity credential and the information concerning the transaction to be added to the SDF. The SDF client API 901 then encapsulates the notification request within an appropriate web services messaging framework, such as a SOAP message. As described earlier, the SDF client API 901 may encrypt the entire SOAP request with the public key of the rights authority 902 and may also sign the entire SOAP request with the client private key and add the signature to the SOAP header. Finally, the SDF client API 901 uses an Internet transfer protocol to transfer the SOAP request representing the enterprise/seller contract notification to the remote rights authority 902.

At block 950, responsive to receipt of the enterprise/seller contract notification from the SDF client API 901, the rights authority 902 validates the signed request using the caller's public key. If the request is determined to have been originated by the purported caller and has not been altered subsequent to being signed, then the rights authority 902 proceeds to decrypt the request using it's private key. Processing then continues with block 960 where the identity credential supplied by the SDF client API 901 is authenticated in a manner similar to that described earlier with reference to block 930.

In the present example, following the seller authentication processing of either block 930 or 960, the rights authority 902 adds the information regarding the new enterprise/seller contract to a local enterprise catalog database to facilitate later access authorization to the software product in response to enterprise user requests to consume licenses, for example.

As described earlier with reference to FIG. 6, it is contemplated that finer levels of granularity than simply local vs. remote may be employed to influence the type and characteristics of message passing between the client, such as SDF client API 901, and the SDF component, such as the rights authority 902. For example, according to one embodiment, if it is determined that the client and the SDF component are running within the same local area network, then certain security measures that would otherwise be employed in connect with message passing between the client and SDF component may be omitted.

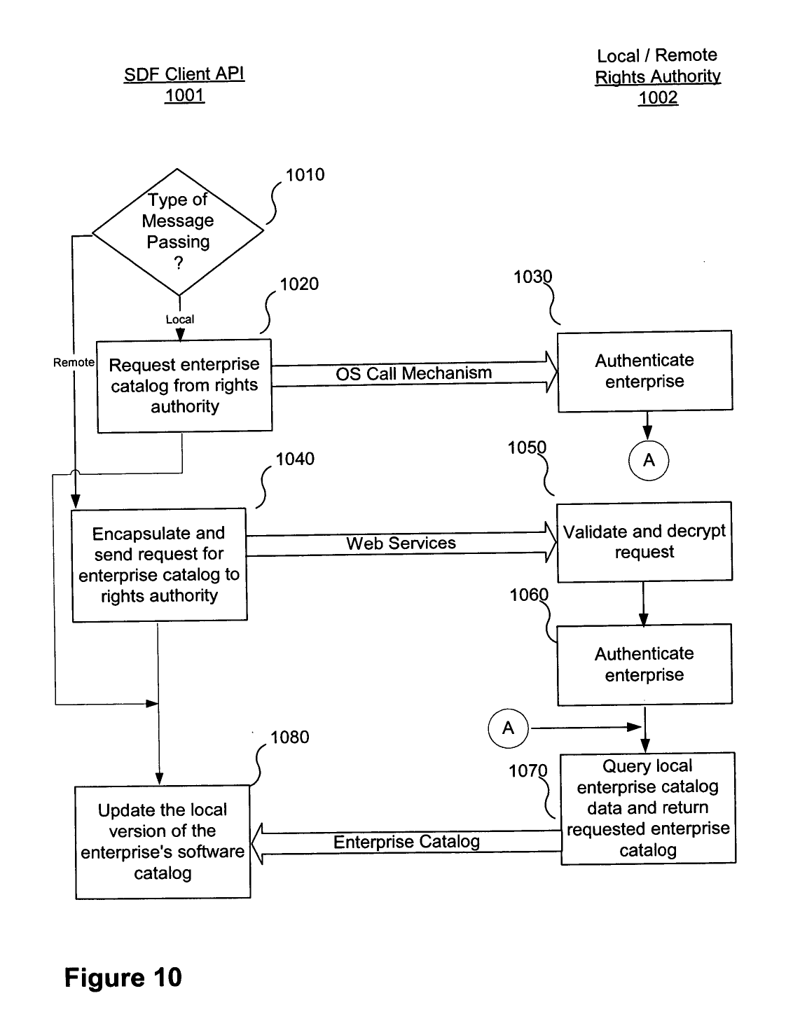

FIG. 10 is a flow diagram illustrating processing involved in retrieving information regarding an enterprise's software licenses from a rights authority 1002 according to one embodiment of the present invention. According to the present example, it is assumed that SDF client API 1001 is associated with a registered enterprise participant in a SDF and has an active session established with the SDF. It is also assumed that information relating to one or more contracts between the enterprise and various sellers from which the enterprise has purchased software licenses has been added to the rights authority 1002.

The retrieval of information regarding the enterprise's software licenses begins at decision block 1010 with the SDF client API 1001 determining the type of message passing to perform in connection with interacting with the rights authority 1002. Such retrieval of information may be initiated as a result of an internal enterprise software audit or responsive to an inquiry regarding available software by an enterprise user, for example. At any rate, in the present example and as discussed above, the type of message passing is based upon the logical proximity of the rights authority 1002 to the SDF client API 1001. If the rights authority 1002 is determined to be local based upon a comparison between the known local domains and the domain name of the rights authority 1002, then processing continues with block 1020. Otherwise, if the rights authority 1002 is determined to be remote, then processing continues with block 1040.

At block 1020, the SDF client API 1001 has determined the rights authority 1002 is local and performs appropriate message passing to request an enterprise catalog from the local rights authority 1002. In the present example, the SDF client API 1001 invokes a method provided by the local rights authority 1002 to request the enterprise catalog by supplying an identity credential, such as the context of the enterprise, and other parameters, if any, specified by the interface definition of the rights authority 1002.

At block 1030, responsive to the SDF client API 1001 request, the local rights authority 1002 authenticates the enterprise based upon the identity credential supplied by the SDF client API 1001. According to one embodiment, authentication may be as described earlier with reference to block 930 of FIG. 9. Additionally, the local rights authority 1002 may confirm the role of the caller is that of an enterprise to preclude SDF participants not operating as enterprise from receiving information regarding software catalogs. At any rate, assuming the supplied identity credential is valid and the role of the caller is that of an enterprise within the SDF, processing continues with block 1070.

At block 1040, the SDF client API 1001 has determined the rights authority 1002 is remote and performs appropriate message passing to request the enterprise catalog from the remote rights authority 1002. The SDF client API 1001 prepares an enterprise catalog request to be communicated to the remote rights authority 1002 containing an identity credential and other parameters, if any, associated with the request. The SDF client API 1001 then encapsulates the request within an appropriate web services messaging framework, such as a SOAP message, and encrypts and signs the message. Finally, the SDF client API 1001 uses an Internet transfer protocol to transfer the SOAP request representing the enterprise catalog request to the remote rights authority 1002.

At block 1050, responsive to receipt of the enterprise catalog request from the SDF client API 1001, the rights authority 1002 validates the signed request using the caller's public key. If the request is determined to have been originated by the purported caller and has not been altered subsequent to being signed, then the rights authority 1002 proceeds to decrypt the request using it's private key. Processing then continues with block 1060 where the identity credential supplied by the SDF client API 1001 is authenticated.

In the present example, following the enterprise authentication processing of either block 1030 or 1060, at block 1070, the rights authority 1002 queries a local enterprise catalog database for the requested catalog of software and returns the catalog of software to the calling enterprise.

At block 1080, the SDF client API 1001 receives from the local or remote rights authority 1002 the requested software catalog representing information regarding currently authorized software that is accessible to enterprise users of the requesting enterprise. In the case of a remote rights authority 1002 returning information via web services in the form of a signed SOAP response, the SDF client API 1001 validates the signed response using the remote rights authority's public key. If the response is determined to be from the rights authority 1002 and has not been altered, then the SDF client API 1001 decrypts the response with the client private key. In the case of either a remote or local rights authority 1002, the software catalog is returned to the enterprise process that initiated the retrieval of the software catalog.

As described earlier, finer levels of granularity than simply local vs. remote may be employed to influence the type and characteristics of message passing between clients and SDF components. Consequently, it should be understood the various examples discussed herein are not intended to be limiting.

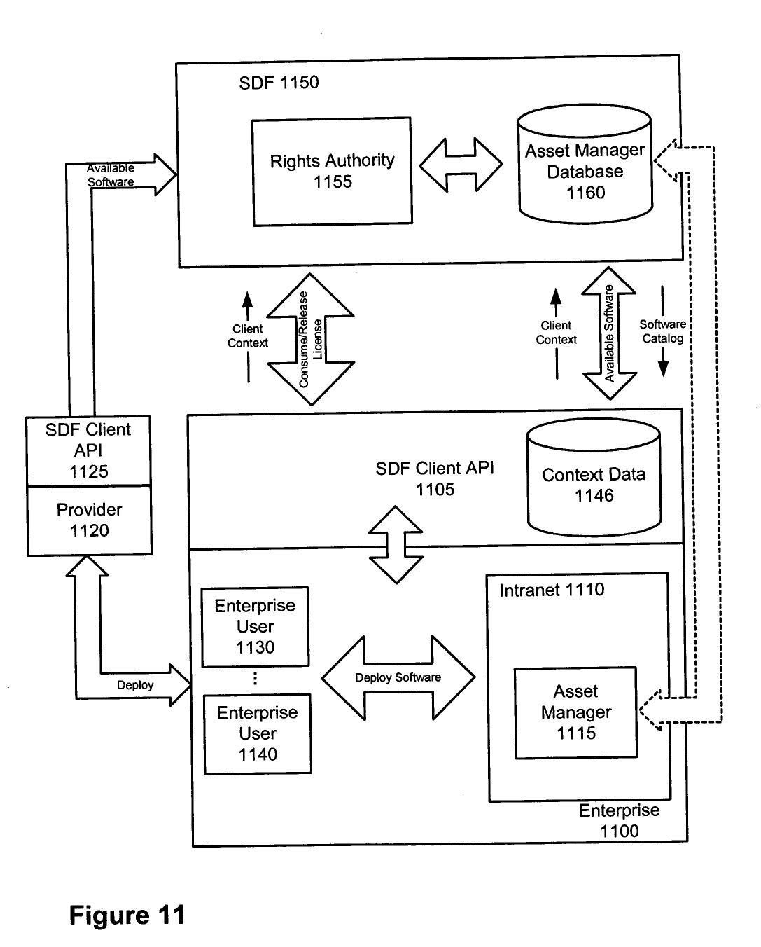

FIG. 11 conceptually illustrates interactions among a rights authority 1155, an enterprise 1100, and a provider 1120 according to one embodiment of the present invention. As above, in the present example, for purposes of simplicity, certain interactions among participants in the SDF and components of the SDF are described at a high-level. For example, local context data stored within the SDF client API 1125 of the provider 1120 is not shown or described and various parameters and return values of certain message passing scenarios are neither shown nor described.

According to the present example, the provider 1120 establishes a managed environment where software may be hosted in a Software-as-a-Service model. The provider 1120 may obtain access to the hosted software by integrating, via web services, for example, with a distributor (not shown). The provider 1125 interacts with the rights authority 1155 of SDF 1150 via an SDF client API 1125 associated with the provider 1120 to determine the availability of hosted software to the enterprise 1100. Additionally, the provider 1120 may also integrate with an entitlement coordinator (not shown) to provide finer grained access control and thereby allow the provider 1125 to distinguish among enterprise users 1130 and 1140 with respect to entitlement to access its hosted software. When the enterprise 1100 purchases software licenses, the provider 1120 may add information to the asset manager database 1160 to track software availability to the enterprise 1100 via the provider 1120.

As above, interactions between the enterprise 1110 and the SDF 1150, such as loading the catalog of software available to the enterprise 1110, are coordinated via an intermediate SDF client API 1105 associated with the enterprise 1100. A data store employed by the SDF client API 1105 to facilitate such interactions with the rights authority 1155 and other SDF component includes context data 1146 which maintains information regarding contexts of active client and/or user sessions with the SDF 1150.

For purposes of simplicity, in the present example, only those portions of the SDF 1150 that are involved in creating, persisting, accessing and/or manipulating information relating to software availability at an enterprise-level are depicted. According to the present example, enterprise users 1130 and 1140 may browse and deploy software to which they are entitled through an asset manager 1115 made available via the enterprise's intranet 1110. When a software license is consumed by an end user, such as enterprise user 1130 or 1140, the rights authority 1155 updates the appropriate asset manager database 1160 record corresponding to the license consumed. Similarly, when a software license is released by an enterprise user 1130 or 1140, the rights authority 1155 updates the appropriate asset manager database 1160 record corresponding to the released license.

According to the present example, after the enterprise 1100 has purchased software licenses for a particular software kit and the rights authority 1155 has been informed of the associated rights and/or limitations of access to the particular software kit, use of the licensed software may commence. According to the present example, enterprise users 1130 and 1140 may browse and deploy software to which they are entitled through an asset manager 1115 made available via the enterprise's intranet 1110.

In the present example, virtualized applications can be deployed in real-time, when enterprise users 1130 and 1140 need them, instead of enterprise users 1130 and 1140 having to wait for assistance with manual installation. With virtualized software solutions, such as SoftGrid-enabled software applications, applications need not be installed on individual desktops, laptops or servers. Instead, applications may be located on a central application server (not shown) and managed from a single enterprise console (not shown). Deployment may then be performed on-demand to enterprise users desktops over the enterprise network (not shown) when the applications are needed.

For sake of illustration, exemplary interactions between and among exemplary roles of SDF participants, e.g., publisher, enterprise, and seller, and exemplary SDF components, e.g., identity manager and rights authority, have been described. Interactions among other roles and SDF components may be accomplished in a manner similar to that described herein. Rather than providing further information concerning other potential interactions among SDF participants and SDF components that should be well understood in view of the foregoing, a brief description of the flexible component architecture will now be provided.

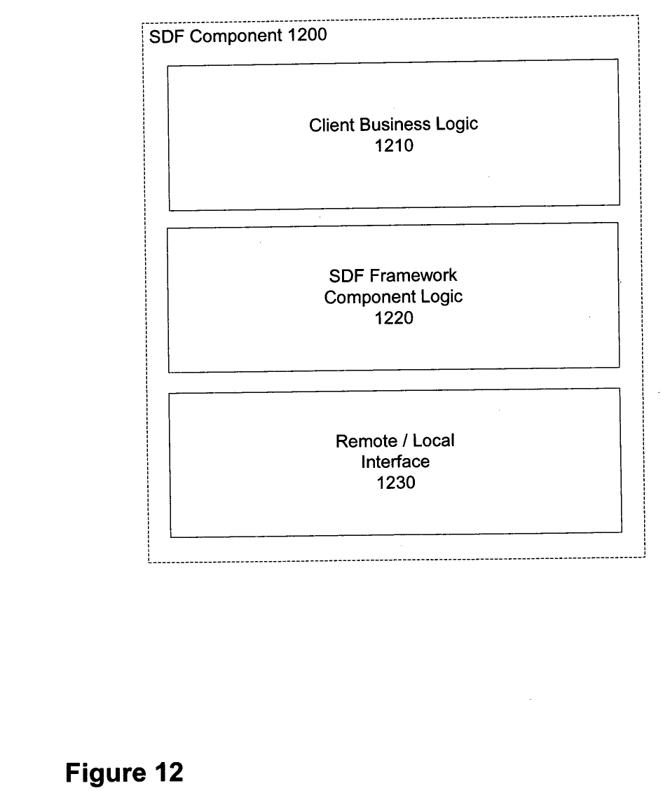

FIG. 12 conceptually illustrates a high-level architectural view of a software distribution (SDF) framework component 1200 according to one embodiment of the present invention. According to the example depicted, the SDF component 1200 includes three elements, i.e., client business logic 1210, SDF framework component logic 1220, and remote/local interface 1230. In one embodiment, the client business logic 1210 may be customized to implement business processes specific to a particular SDF participant. Such customization may facilitate integration of the SDF with legacy software procurement and/or deployment procedures, for example. In some embodiments, the client business logic 1210 may not be customized and may be instantiated with predefined logic flow. The preceding flow diagrams and use cases described below illustrate various functionality that may be performed within the client business logic 1210.

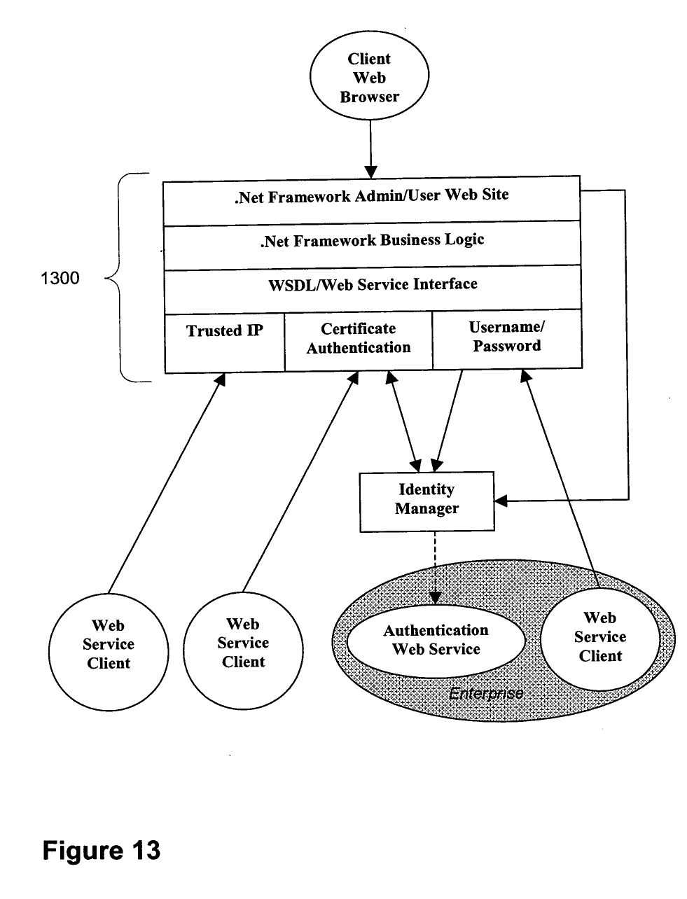

The remote/local interface 1230 generally operates as an intermediary between the client business logic 1210 and the SDF framework component logic 1220. In one embodiment, the remote/local interface 1230 handles encryption/decryption, the particulars of message passing, validation, data formatting and/or networking protocols. When the SDF framework component 1200 is remote from enterprise or machine upon which the SDF client API resides, the remote/local interface 1230 may be implemented as a WSDL/web services interface as shown in the SDF component architecture 1300 of FIG. 13. When the SDF framework component 1200 is local to the machine upon which the SDF client API resides, the remote/local interface 1230 may rely upon operating system call mechanisms, such as RPC, ORPC or COM, to interact with the client business logic 1210.

In one embodiment, the SDF framework component logic 1220 implements various authentication and/or request validation processes. The SDF framework component logic 1220 also typically includes software to perform the core functionality or service being requested by the SDF participant.

According to one embodiment, the three elements of the SDF component 1200 are loosely coupled in order to allow the elements to be distributed in any manner appropriate for the particular implementation. The extremes range from all elements 1210, 1220 and 1230 residing local to a particular SDF participant to all elements 1210, 1220 and 1230 residing remote from the SDF participant and implemented as web services, such as .NET framework components, for example. Alternatively, one or more of the elements 1210, 1220 and 1230 may be local to the SDF participant and others may be remote. Notably, while the component architecture may be common, each SDF participant's configuration and business logic implementation is independent of the others.

In an implementation of the SDF in which the SDF component 1200 is customized in accordance with the needs of a particular SDF participant, such as an enterprise, the client business logic 1210, may be implemented as part of the SDF client API and may reside on the same or separate machine as the SDF client API within a local or wide area network of the enterprise. In other implementations, all elements 1210, 1220 and 1230 may reside and execute local to the enterprise or even on the same machine as the SDF client API. According to one embodiment, to facilitate openness of the SDF and ease of integration into the SDF, all components of the SDF, such as the identity manager 245, rights authority 225, entitlement coordinator 220, and desktop manager 230, are implemented having similar architectures and/or interfaces.

According to one embodiment, several utilities and services are made available to each high-level functional component of the SDF. For example, utilities may include request management (e.g., adding a Globally Unique Identifier (GUID) or equivalent to each request to facilitate activity reporting across components as well as protection against Denial of Service attacks) and security (e.g., ensuring that each component is secured in a consistent manner). Additionally, logging and event management services may be provided. According to one embodiment, these services may be provided to each functional component by means of abstract classes and methods. In such an embodiment, each component may be responsible for creating concrete classes above the provided abstractions. As a result, capabilities may be customized and configured within the concrete class that are specific to the component being developed. To facilitate development, most of the capability may be implemented in the abstract class, such as logging and event notification functionality.

As a result of the flexibility provided by the various embodiments of the content distribution framework and component architecture described herein, it should be appreciated that it is not feasible to comprehensively describe all possible usage scenarios and interactions between or among participants and components. Consequently, various use cases are provided below in order to facilitate understanding of the flexible nature of the described framework and illustrate the diverse types of usage models that can be created by tailoring one or more of the client business logic 1210, the SDF framework component logic 1220 and/or the remote local interface 1230.

The following use-case scenarios describe various administrator and/or user interactions with the SDF involving software product license entitlement, purchase and management. These use-cases are meant to provide examples and should not be considered to be all-inclusive or static. Furthermore, while certain of the use-cases relate to different usage models, the use-cases should not be considered mutually exclusive.

Use-Case Scenario #1

In this use-case scenario the enterprise is assumed to have purchased an enterprise license for a software product to be used throughout the company. The purchase (e.g., the enterprise/seller contract) is registered in the SDF. The SDF may be made aware of the purchase by automatic registration through integration with the seller back-office, as part of the transaction flow between the enterprise and the seller, or a privileged user of the seller or the enterprise may register the purchase in SDF via an administrative interface.

After the software product purchase has been registered with the SDF, a privileged user of the enterprise may interact with the entitlement coordinator to entitle all enterprise users to the software product. Thereafter, upon request, enterprise users may be presented with an available catalog of software, including the newly purchased software product, from which they may download and install desired software products to their workstation.

Use-Case Scenario #2

In this use-case scenario, it is assumed that a department or some other organizational unit of an enterprise has purchased a fixed number of copies of a software product for use in the particular organizational unit. As above, the purchase of the licenses to the software product is registered with SDF. However, in this use-case scenario, rather than entitling all enterprise users to the software product, an administrator or other privileged user associated with the department or other organizational unit that made the purchase may entitle only those enterprise users associated with the department or particular organizational unit to the fixed number of copies available. Additionally, the privileged user may restrict enterprise users within the particular organizational unit from access to product if desired.

As above, authorized users having entitlement to one or more software products may be presented with a list of software products that are available to them for downloading and installation on their workstation.

To facilitate license management, the privileged user may set a notification threshold within the entitlement coordinator to cause the entitlement coordinator to notify the privileged user or administrator when the number of available licenses to a particular software product drops below the notification threshold (e.g., entitlement is running out).

Use-Case Scenario #3

According to this use-case scenario, an enterprise is provided with the ability to control software product license usage for project-based software products without using metering or other monitoring tools. According to one embodiment, when an enterprise user indicates his/her desire to consume a license for a particular software product, a justification is solicited from the enterprise user by presenting the enterprise user with a check-box form or free text comment box. Responsive to the request for the particular software product, the SDF may be configured to verify approval process participants for the particular software product at the enterprise and notify one or more approvers of the request for the particular software product via email, for example. After reviewing the request, the approver may grant or deny the entitlement request.

Assuming the entitlement request is granted, the approver may optionally specify a time period of entitlement by specifying an end-date of entitlement, for example. The requesting enterprise user is notified of the disposition of the entitlement request. Assuming the enterprise user's entitlement request has been granted, the user may then employ the enterprise's software deployment mechanism, such as an enterprise intranet, for installation and download of the software product from the SDF. Upon expiration of the entitlement time period, the SDF may remove the enterprise user's entitlement, notify the enterprise user of the expiration of the entitlement time period, and notify the enterprise user to uninstall the software product from their workstation.

In an alternative embodiment, the enterprise administrator may entitle an entire department or other organizational unit of the enterprise to a particular software product for use in connection with a current project. At entitlement, the enterprise administrator may specify a date that entitlement should end. Project members may then download and install the particular software product as needed. However, when the end entitlement date is reached, project members can no longer access the software product in SDF; and all project members that received the software product are notified to remove software from their workstations.

Use-Case Scenario #4

According to this use-case scenario, an enterprise is provided with the ability to allocate management of software product licenses and administration of same to a department or other organizational unit of the enterprise. An enterprise administrator may allocate a fixed number of software product licenses to a particular organizational unit of the enterprise. The enterprise administrator may also set the allocation cost of an individual software product license to a specified value.

An administrator associated with the particular organizational unit establishes which of the enterprise users in the particular organizational unit are entitled to one of the fixed number of software product licenses. On a periodic basis or as software product licenses are consumed by the authorized enterprise users, the enterprise administrator is notified and based upon the license usage information can generate finance/billing reports to charge the particular organizational unit for the software product licenses used.

Use-Case Scenario #5

According to this use-case scenario, an information technology (IT) administrator or a desktop engineering team is responsible for all software product installations and entitlements. In one embodiment, a push distribution mechanism is employed. Software product licenses are entitled to enterprise users via an administrative console. The IT administrator may use an asset install feature to select a software product to be deployed to a particular enterprise user's workstation. Responsive to the installation request, the SDF sends a transaction to a push deployment tool to install the selected software product on the particular user's machine.

In an alternative embodiment, the software product deployment process may involve a desktop visit by the IT administrator or a member of the desktop engineering team. As a result of an enterprise user requesting a software product license via the SDF, an enterprise approval process may notify the IT administrator to entitle the requesting enterprise user to the software product license via an administrative console. On approval/entitlement, the desktop engineering team may be sent automatic notification of the entitlement. Responsive to the notification of entitlement, the desktop engineering team schedules a visit with the enterprise user to install the software product on the enterprise user's machine.

Use-Case Scenario #6

According to this use-case scenario, an enterprise may act as a publisher for itself. For example, an enterprise may use the SDF as a platform for distribution of internally developed software tools to enterprise users. An enterprise administrator may create a license for a software product that represents an internally developed software tool, for example, and register the software product with the SDF. The software kit that is used to install that product can be uploaded to the SDF distribution site, or alternate internal distribution server (e.g., file share). As described above, the enterprise as a whole, certain departments and/or communities or specific users can be entitled to the software product using SDF request/approve/entitlement processes and such entitled users may thereafter obtain access to the software product.

Use-Case Scenario #7

According to this use-case scenario, an enterprise user is provided with the ability to obtain a copy of a software product that has been internally developed or otherwise requires no license for deployment. As described earlier, a catalog of available software products may be displayed via an intranet site. An enterprise user selects the software product desired from the list of available software products and is presented with appropriate deployment options. The enterprise user selects the desired deployment option and the software product is made available.

Use-Case Scenario #8

According to this use-case scenario, an enterprise user is provided with the ability to obtain a copy of a software product for which the enterprise owns and has available a sufficient number of licenses. As described earlier, a catalog of available software products may be displayed via an intranet site. Responsive to receiving a request for a particular software product through the catalog interface, the SDF client API of the enterprise checks with the rights authority to ensure that a license is available for the requested software product. If a license is available, the enterprise user is directed to an appropriate web page to guide him/her through the software download and installation process.

Use-Case Scenario #9

According to this use-case scenario, an enterprise user having appropriate privileges is provided with the ability to initiate the purchase of a software product license via the enterprise's procurement system. As described earlier, an enterprise user desirous of obtaining a particular software product may view a catalog of available software products via an enterprise intranet site. Upon receiving a request for a particular software product through the catalog interface, the SDF client API of the enterprise checks with the rights authority to determine whether a license is available for the requested software product. If no licenses are available, the enterprise user may be re-directed to an external procurement system, such as Ariba's Procurement Solution, to purchase software from a seller's software catalog, such as a software catalog provided by Software Spectrum, Inc. (SSI). Alternatively, the privileged enterprise user may directly access the external procurement system directly in response to a notification from the SDF that entitlement is running low or has been exhausted, for example, without being re-directed via the enterprise-displayed software catalog. Additionally, the privileged enterprise user may directly access the external procurement system to purchase new software licenses for products to which the enterprise is not currently entitled. Furthermore, prior to completing a transaction relating to the purchase of software licenses, the external procurement system may query the SDF to verify the enterprise's current entitlement level and may notify the privileged enterprise user of the current level of entitlement if the enterprise already has existing licenses to the requested software product.

Within the external procurement system, the enterprise user selects the desired software product, checks out and processes the shopping cart (subject to a possible approval process depending upon the enterprise software procurement workflow process). The external procurement system sends an order for the software product to the seller for processing. The seller e-commerce site sends a transaction to the SDF to register the new purchase and the enterprise user is sent confirmation. Enterprise users may now use the internal web-site as described above to download and install the newly purchased software product.

Use-Case Scenario #10

According to this use-case scenario, an enterprise user having appropriate privileges may procure licenses for a software product via an e-commerce site. Upon checkout/purchase, an order is sent to the seller e-commerce site. The seller e-commerce site sends a transaction to the SDF to register the new purchase and the enterprise user is sent confirmation. Finally, the enterprise user is notified of entitlement, and can download the newly licensed software or manage entitlements to the licenses.

Use-Case Scenario #11

According to this use-case scenario, an enterprise user having appropriate privileges may procure licenses for a software product via the enterprise's internal site. The enterprise may display a catalog of software on an intranet site of all items available to authorized enterprise users. As described earlier, an enterprise user desirous of obtaining a particular software product may view a catalog of available software products via the enterprise intranet site. Upon receiving a request for a particular software product through the catalog interface, the SDF client API of the enterprise checks with the rights authority to determine whether a license is available for the requested software product. If no licenses are available, the enterprise user may be re-directed to an e-commerce site associated with a seller. Alternatively, an enterprise user having appropriate privileges may directly access the e-commerce site to purchase new software licenses for products to which the enterprise is not currently entitled or additional licenses for software products already employed by the enterprise.

In any event, once at the e-commerce site, the enterprise user may select the desired software product, check out and process the shopping cart. The shopping cart is returned to the SDF internal cart for approval. The SDF routes email messages for approval as determined by the enterprise's approval process. On final approval, the SDF sends an order to the seller for processing. The seller e-commerce site sends a transaction to SDF to register the new purchase and the enterprise user is sent confirmation. Enterprise users may now use the internal web-site as described above to download and install the newly purchased software product.

Various other scenarios are envisioned to customize the SDF to accommodate a particular enterprise's workflow and business processes. For example, the SDF may implement approval mechanisms to verify approval of software license purchases when manager approval is required. Furthermore, administrators may be provided with the ability to make licenses not used by a department available to another department within an enterprise. For example, an administrator may view the entitlements and consumption of licenses within a department. Licenses that have not been consumed by a department can be un-entitled from that department and entitled to a different department (or entitled to specific enterprise users).

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A digital content distribution system comprising:
a credentialing authority component configured to receive encryption keys associated with each of a plurality of participants in the digital content distribution system and assign each of the plurality of participants an identity certificate for use during subsequent interactions with components of the digital content distribution system;
an access control component configured to maintain information regarding access rights of the plurality of participants to digital content accessible via the digital content distribution system; and
a digital content distribution system interface corresponding to each of the plurality of participants, the digital content distribution system interface capable of being customized for the corresponding participant and configured to coordinate interactions among the corresponding participant and the components of the digital content distribution system according to predetermined business processes associated with the corresponding participant.

2. The system of claim 1, wherein one or more of the components are implemented as web services.

3. The system of claim 1, wherein the digital content distribution system interface is configured to coordinate interactions among the corresponding participant and a component of the digital content distribution system including determining a type of message passing to be employed with the component based upon information regarding a computer system upon which the digital content distribution system interface is running and information regarding a computer system upon which the component is running.

4. The system of claim 1, wherein the credentialing authority component is configured to issue identity credentials responsive to session establishment requests.

5. The system of claim 1, wherein the plurality of participants includes a content publisher and a plurality of enterprise content consumers, and wherein the access control component is configured to maintain information regarding access rights of each of the plurality of enterprise content consumers to software products made accessible via the digital content distribution system directly or indirectly from the content publisher.

6. A digital content distribution system comprising:
a plurality of components providing services in support of digital content distribution, the plurality of components including a credentialing authority component and an access control component, each of a plurality of participants in the digital content distribution system registers with the credentialing authority, the plurality of participants including a content publisher and a plurality of enterprise content consumers, in response to a registration request by or on behalf of a participant of the plurality of participants, the credentialing authority component is configured to receive a public key associated with the participant, assign the participant a unique resource identifier (URI) that uniquely identifies the participant within the digital content distribution system, and return an identity certificate for use by the participant during subsequent interactions with other of the plurality of components;
an access control component configured to maintain information regarding access rights of each of the plurality of enterprise content consumers to digital content made accessible via the digital content distribution system directly or indirectly from the content publisher; and
a digital content distribution system interface corresponding to each of the plurality of participants, the digital content distribution system interface capable of being customized for the corresponding participant and configured to coordinate interactions among the corresponding participant and a plurality of components of the digital content distribution system according to predetermined business processes associated with the corresponding participant.

7. The system of claim 6, wherein the participant comprises an enterprise content consumer of the plurality of enterprise content consumers and the credentialing authority component authenticates individual users of the enterprise content consumer by directly or indirectly requesting a web service associated with the enterprise content consumer to perform authentication of individual users purporting to be affiliated with the enterprise content consumer.

8. The system of claim 6, wherein the participant comprises an enterprise content consumer of the plurality of enterprise content consumers and the credentialing authority component authenticates individual users purporting to be affiliated with the enterprise content consumer by confirming the individual users are among a list of authorized users provided by the enterprise content consumer.

9. The system of claim 8, wherein the list of authorized users provided by the enterprise content consumer is periodically updated based upon enterprise user data transmitted by the enterprise content consumer to the credentialing authority.

10. A digital content distribution system comprising:
a plurality of components providing services in support of digital content distribution, the plurality of components including a credentialing authority component and an access control component, each of a plurality of participants in the digital content distribution system registers with the credentialing authority, the credentialing authority component is configured to receive an encryption key associated with a participant and assign the participant an identity certificate for use by the participant during subsequent interactions with other of the plurality of components;
an access control component configured to maintain information regarding access rights of the plurality of participants to digital content accessible via the digital content distribution system; and
a digital content distribution system interface corresponding to each of the plurality of participants, the digital content distribution system interface configured to coordinate interactions among the corresponding participant and a component of the plurality of components of the digital content distribution system including determining a type of message passing to be employed with the component based upon information regarding a computer system upon which the digital content distribution system interface is running and information regarding a computer system upon which the component is running.

11. The system of claim 10, wherein the digital content distribution system interface is capable of being customized for the corresponding participant and configured to coordinate interactions among the corresponding participant and the plurality of components of the digital content distribution system according to predetermined business processes associated with the corresponding participant.

12. The system of claim 10, wherein one or more of the plurality of components are implemented as web services.

13. The system of claim 10, wherein the credentialing authority component is configured to issue identity credentials responsive to a session establishment requests.

14. The system of claim 10, wherein the plurality of participants includes a content publisher and a plurality of enterprise content consumers.

15. The system of claim 14, wherein the access control component is configured to maintain information regarding access rights of each of the plurality of enterprise content consumers to software products made accessible via the digital content distribution system directly or indirectly from the content publisher.

16. The system of claim 14, wherein one or more of the plurality of components reside on a computer system within an enterprise content consumer of the plurality of enterprise content consumers.

17. A software distribution system comprising:
a plurality of components providing services in support of software distribution, the plurality of components including a credentialing authority component and an access control component, each of a plurality of participants in the software distribution system registers with the credentialing authority, the plurality of participants including a publisher and a plurality of enterprises, in response to a registration request by or on behalf of a participant of the plurality of participants, the credentialing authority component is configured to receive a public key associated with the participant, assign the participant a unique resource identifier (URI) that uniquely identifies the participant within the software distribution system, and return an identity certificate for use by the participant during subsequent interactions with other of the plurality of components;
an access control component configured to maintain information regarding access rights of each of the plurality of enterprises to software products made accessible via the software distribution system directly or indirectly from the publisher; and
a software distribution system interface corresponding to each of the plurality of participants, the software distribution system interface configured to coordinate interactions among the corresponding participant and a plurality of components of the software distribution system including determining a type of message passing to be employed with the plurality of components based upon information regarding a computer system upon which the digital content distribution system interface is running and information regarding a computer system upon which the particular component is running.

18. A digital content distribution system comprising:
a plurality of components providing one or more services in support of digital content distribution; and
a credentialing authority component with which each of a plurality of participants in the digital content distribution system registers, responsive to a session establishment request from a registered participant of the plurality of participants, the credentialing authority being configured to provide to the registered participant an identity credential that enables the registered participant to obtain access to content distribution services provided by the plurality of components.

19. A computer-implemented method comprising:
receiving a session establishment request at an identity management component of a plurality of components of a digital content distribution system from a registered participant of a plurality of registered participants of the digital content distribution system; and
the identity management component generating and returning to the registered participant an identity credential digitally signed by the identity management component, the identity credential allowing the registered participant to obtain access to content distribution services provided by the plurality of components of the digital content distribution system.

20. The method of claim 19, wherein the registered participant comprises an enterprise, and wherein a type of message passing used in connection with the session establishment request is selected by an Application Programming Interface (API) residing on a computer system associated with the enterprise based upon information regarding logical proximity between the identity management component and the API.

21. The method of claim 20, wherein the identity management component comprises a web service.

22. The method of claim 21, wherein the selected type of message passing is web services and the session establishment request is generated in the form of a Simple Object Access Protocol (SOAP) request.

23. The method of claim 20, wherein the identity management component comprises a program executing on the computer system associated with the enterprise.

24. The method of claim 23, wherein the selected type of message passing is an operating system call mechanism and the session establishment request is conveyed to the identity management component by invoking a method of the identity management component.

25. The method of claim 20, further comprising the API coordinating interactions among the plurality of components of the digital content distribution system and the enterprise in accordance with predetermined business processes associated with the enterprise.

26. The method of claim 19 embodied in instructions stored on a computer-readable medium which, when executed by a processor, cause the processor to perform the method.

27. A computer-implemented method comprising:
receiving a session establishment request at an identity management component of a digital content distribution system from a registered participant of a plurality of registered participants of the digital content distribution system, the plurality of registered participants including at least a content publisher that provides digital content to the digital content distribution system for consumption by other of the plurality of registered participants and a content consumer organization that consumes the digital content from the digital content distribution system, the session establishment request including (i) information indicative of a unique resource identifier (URI) that uniquely identities the registered participant within the digital content distribution system and (ii) information indicative of a public key associated with the registered participant;
the identity management component storing the public key associated with the registered participant in a key datastore; and
the identity management component generating and returning to the registered participant an identity credential digitally signed by the identity management component with a private key associated with the identity management component, the identity credential allowing the registered participant to obtain access to content distribution services provided by a plurality of other components of the digital content distribution system.

28. The method of claim 27, wherein the registered participant comprises the content consumer organization, and wherein a type of message passing used in connection with the session establishment request is selected by an Application Programming Interface (API) residing on a computer system associated with the content consumer organization based upon information regarding a domain with which the identity management component is associated.

29. The method of claim 28, wherein the identity management component comprises a web service.

30. The method of claim 29, wherein the selected type of message passing is web services and the session establishment request is generated in the form of a Simple Object Access Protocol (SOAP) request.

31. The method of claim 28, wherein the identity management component comprises a program executing on the computer system associated with the content consumer organization.

32. The method of claim 31, wherein the selected type of message passing is an operating system call mechanism and the session establishment request is conveyed to the identity management component by invoking a method of the identity management component.

33. The method of claim 28, further comprising the API coordinating interactions among the plurality of other components of the digital content distribution system and the content consumer organization in accordance with predetermined business processes associated with the content consumer organization.

34. The method of claim 27 embodied in instructions stored on a computer-readable medium which, when executed by a processor, cause the processor to perform the method.

35. The method of claim 27, wherein the digital content comprises software products.

36. A software distribution system comprising:
a plurality of components each providing one or more services in support of software distribution; and
an access control component, communicatively coupled to a plurality of participants in the software distribution system via a network, configured to maintain information regarding access rights of the plurality of participants to software products that are accessible via the software distribution system, the software products created by one of the plurality of participants,
validate requests from content consumer participants of the plurality of participants to consume licenses relating to the software products,
authenticate the requests, and
selectively authorize valid and authenticated requests based upon the information regarding access rights associated with the content consumer participants.

37. A method of managing rights to software comprising:
receiving a notification regarding an enterprise/seller contract relating to a software product stored by an access control component of a software distribution system, the notification containing information regarding the enterprise/seller contract including information indicative of an enterprise consumer participant of a plurality of registered participants in the software distribution system and information indicative of the software product;
receiving a consumption request at the access control component from the enterprise consumer participant, the consumption request including information indicative of the software product and an identity credential issued by a credentialing authority component of the software distribution system;
responsive to the consumption request, the access control component validating the consumption request and authenticating the identity of the enterprise consumer participant based upon the identity credential; and
after confirming the validity of the consumption request and confirming the identity of the enterprise consumer participant, transmitting digital content representing the software product to the enterprise consumer participant.

38. The method of claim 37, wherein a type of message passing used in connection with the consumption request is selected by an Application Programming Interface (API) residing on a computer system associated with the enterprise consumer participant based upon information regarding logical proximity between the access control component and the API.

39. The method of claim 38, wherein the access control component comprises a web service.

40. The method of claim 39, wherein the selected type of message passing is web services and the consumption request is generated in the form of a Simple Object Access Protocol (SOAP) request.

41. The method of claim 38, wherein the access control component comprises a program executing on the computer system associated with the enterprise consumer participant.

42. The method of claim 41, wherein the selected type of message passing is an operating system call mechanism and the consumption request is conveyed to the access control component by invoking a method of the access control component.

43. The method of claim 38, further comprising the API coordinating interactions among a plurality of components of the software distribution system and the enterprise consumer participant in accordance with predetermined business processes associated with the enterprise consumer participant.

44. The method of claim 37 embodied in instructions stored on a computer-readable medium which, when executed by a processor, cause the processor to perform the method.

45. A method of managing rights to software comprising:
receiving digital content representing a software kit at an access control component of a software distribution system from a publisher participant of a plurality of registered participants in the software distribution system;
the access control component storing the software kit for subsequent release to one or more enterprise consumers of the plurality of registered participants that are authorized to consume the digital content;
receiving a notification of an enterprise/seller contract relating to the software kit at the access control component, the notification containing information regarding the enterprise/seller contract including information indicative of an enterprise consumer participant of the plurality of registered participants, information indicative of the software kit, information indicative of a number of licenses to the software kit that have been purchased by the enterprise consumer participant;
receiving a consumption request at the access control component from the enterprise consumer participant, the consumption request including information indicative of the software kit and an identity credential issued and digitally signed by a credentialing authority component of the software distribution system;
responsive to the consumption request, the access control component validating the consumption request and authenticating the identity of the enterprise consumer participant based upon the identity credential; and
after confirming the validity of the consumption request and confirming the identity of the enterprise consumer participant, transmitting the digital content to the enterprise consumer participant.

46. The method of claim 45, wherein a type of message passing used in connection with the consumption request is selected by an Application Programming Interface (API) residing on a computer system associated with the enterprise consumer participant based upon information regarding logical proximity between the access control component and the API.

47. The method of claim 46, wherein the access control component comprises a web service.

48. The method of claim 47, wherein the selected type of message passing is web services and the consumption request is generated in the form of a Simple Object Access Protocol (SOAP) request.

49. The method of claim 46, wherein the access control component comprises a program executing on the computer system associated with the enterprise consumer participant.

50. The method of claim 49, wherein the selected type of message passing is an operating system call mechanism and the consumption request is conveyed to the access control component by invoking a method of the access control component.

51. The method of claim 46, further comprising the API coordinating interactions among a plurality of components of the software distribution system and the enterprise consumer participant in accordance with predetermined business processes associated with the enterprise consumer participant.

52. The method of claim 45 embodied in instructions stored on a computer-readable medium which, when executed by a processor, cause the processor to perform the method.
